(19) United States
(12) Patent Application Publication
(10) Pub. No.: US 2020/0304034 A1
(43) Pub. Date: Sep. 24, 2020

(54) SWITCHED-MODE POWER SUPPLY AND SELF-DRIVING DEVICE

(71) Applicants: Kabushiki Kaisha Toshiba, Tokyo (JP); Toshiba Electronic Devices & Storage Corporation, Tokyo (JP)

(72) Inventor: Toshimasa Namekawa, Ota Tokyo (JP)

(21) Appl. No.: 16/566,547

(22) Filed: Sep. 10, 2019

(30) Foreign Application Priority Data
Mar. 20, 2019 (JP) 2019-052950

(51) Int. Cl. H02M 3/335; H02M 3/338

(52) U.S. Cl. CPC H02M 3/33592; H02M 3/338

(57) ABSTRACT

A switched-mode power supply according to an embodiment comprises a switching circuit, a smoothing circuit, a differential-signal output circuit, a signal output circuit, a pulse-drive signal output circuit, and a signal generation circuit. The differential-signal output circuit is configured to output a differential signal based on a potential difference between the output voltage and a reference potential. The signal output circuit is configured to generate a signal synchronous. The pulse-drive signal output circuit is configured to adjust a time ratio of outputting the voltage on a basis of a time point when the differential signal and the signal have a same value. The signal generation circuit is configured to generate at least either the differential signal or the signal to cause an interval from a base time in one cycle of the clock signal to the time point to decrease as the input voltage increases.

### CROSS-REFERENCE TO RELATED APPLICATIONS

This application is based upon and claims the benefit of priority from Japanese Patent Application No. 2019-052950, filed on Mar. 20, 2019; the entire contents of which are incorporated herein by reference.

### FIELD

Embodiments of the present invention relate to a switched-mode power supply and a self-driving device.

### BACKGROUND

Components constituting a self-driving device, such as a controlling computer and a maneuvering motor, require a power supply that can stably supply power. Power consumption of the controlling computer or the maneuvering motor is characterized in being large and fluctuating greatly. Therefore, it is considered that use of a switched-mode power supply having an advantage in power efficiency is appropriate.

However, in a self-driving device and the like, the difference between the upper limit and the lower limit of an input voltage fluctuates, for example, about ten times and a conventional switched-mode power supply that mainly controls the current has a risk that the response characteristics and the stability decrease. Accordingly, a switched-mode power supply that can have both the response characteristics and the stability also in a case where the difference between the upper limit and the lower limit of an input voltage increases is demanded.

### BRIEF DESCRIPTION OF THE DRAWINGS

FIG. 1 is a diagram illustrating a configuration example of a switched-mode power supply according to a first embodiment;

FIG. 2 is a diagram illustrating operation waveforms of the switched-mode power supply according to the first embodiment;

FIGS. 3A to 3C are Bode plots illustrating the stability provided by feedback control on an output voltage;

FIG. 4 is an operation waveform diagram illustrating an effect example of the switched-mode power supply according to the first embodiment;

FIG. 5 is a detailed configuration example of a switched-mode power supply according to a second embodiment;

FIG. 6 is a diagram illustrating a configuration example of a switched-mode power supply according to a third embodiment;

FIG. 7 is a diagram illustrating input/output characteristics of a gain compensator;

FIG. 8 is a diagram illustrating a gain compensation ratio of the gain compensator;

FIG. 9 is a diagram illustrating a relation between an input voltage and the gain compensation ratio;

FIG. 10 is a diagram illustrating a configuration example of a switched-mode power supply according to a fourth embodiment;

FIG. 11 is a diagram illustrating an operation waveform of a gain compensated signal SawGcmp;

FIG. 12 is a diagram illustrating a configuration example of a switched-mode power supply according to a fifth embodiment;

FIG. 13 is a diagram illustrating an operation waveform of a gain-compensating generator;

FIG. 14 is a diagram illustrating an example of compensation of small-signal transfer gain characteristics according to the fifth embodiment;

FIG. 15 is a diagram illustrating a configuration example of a switched-mode power supply according to a sixth embodiment;

FIG. 16 is a diagram illustrating a detailed configuration example of a gain-compensating generator used in the sixth embodiment;

FIG. 17 is a waveform chart for explaining an operation according to the sixth embodiment;

FIG. 18A is a Bode plot of a feedback control loop; and

FIG. 18B is a diagram illustrating the dependency on an input voltage of a small-signal gain-frequency product obtained from the Bode plot.

### DETAILED DESCRIPTION

A switched-mode power supply according to an embodiment comprises a switching circuit, a smoothing circuit, a differential-signal output circuit, a signal output circuit, a pulse-drive signal output circuit, and a signal generation circuit. The switching circuit is configured to switch an input voltage according to a pulse drive signal synchronous with a clock signal to output a voltage of a pulse waveform. The smoothing circuit is configured to convert the voltage of the pulse waveform into a DC voltage to output an output voltage. The differential-signal output circuit is configured to output a differential signal based on a potential difference between the output voltage and a reference potential. The signal output circuit is configured to generate a signal synchronous with the clock signal. The pulse-drive signal output circuit is configured to adjust a time ratio of outputting the voltage on a basis of a time point when the differential signal and the signal have a same value, and to output the pulse drive signal. The signal generation circuit is configured to generate at least either the differential signal or the signal to cause an interval from a base time in one cycle of the clock signal to the time point to decrease as the input voltage increases.

Embodiments of the present invention will be explained below with reference to the accompanying drawings. Note that the scale, the ratio between vertical and horizontal dimensions, and the like in the accompanying drawings of the specification of the present application are appropriately changed or magnified from actual ones for easier illustrations and understanding.

### FIRST EMBODIMENT

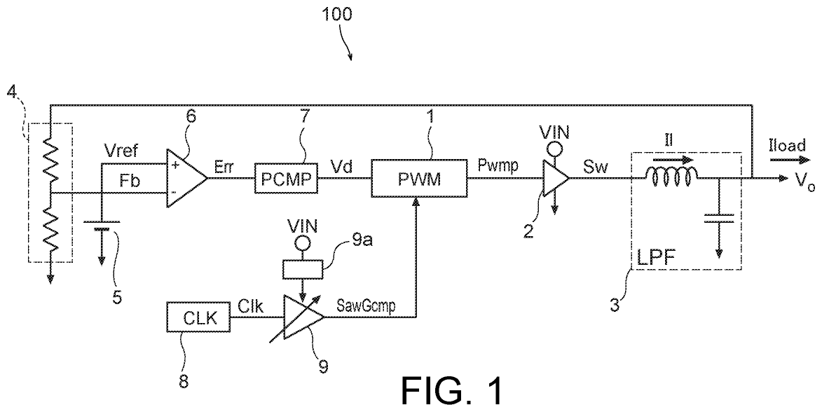

FIG. 1 is a diagram illustrating a configuration example of a switched-mode power supply 100 according to a first embodiment. The switched-mode power supply 100 outputs an input voltage Vi of an input power supply VIN as an output voltage Vo. The switched-mode power supply 100 is configured to include a pulse width modulator 1 (hereinafter, “PWM 1”), a switching driver 2, a LC low-pass filter 3, a voltage divider 4, a reference voltage source 5, an error amplifier 6, a phase compensator 7 (hereinafter, “PCMP 7”), a clock oscillator 8 (hereinafter, also “CLK 8”), a gain-compensating generator 9 (hereinafter, also “generator 9”), and a low-pass filter 9a. The voltage value of the input power supply VIN is, for example, 4 volts to 40 volts and the difference between the upper limit and the lower limit of the voltage value reaches about ten times. The switched-mode power supply 100 can be used for a controlling computer, a maneuvering motor, and the like constituting a self-driving device that autonomously drives an automobile.

The PWM 1 receives a duty-designation voltage signal Vd and an amplitude modulated signal SawGcmp as inputs and outputs a pulse-width modulated signal Pwmp synchronous with the amplitude modulated signal SawGcmp. The amplitude modulated signal SawGcmp has a sawtooth wave and the pulse-width modulated signal Pwmp has a rectangular wave. More specifically, the PWM 1 compares the voltages between the duty-designation voltage signal Vd and the amplitude modulated signal SawGcmp. Accordingly, the PWM 1 outputs the pulse-width modulated signal Pwmp being Hi when the amplitude modulated signal SawGcmp is smaller than the duty-designation voltage signal Vd, and outputs the pulse-width modulated signal Pwmp being Low when the amplitude modulated signal SawGcmp is larger than the duty-designation voltage signal Vd. That is, the PWM 1 adjusts the ratio of a time to output a voltage on the basis of a time point when the duty-designation voltage signal Vd and the amplitude modulated signal SawGcmp have a same value, and outputs the pulse-width modulated signal Pwmp synchronous with a clock signal. The PWM 1 according to the present embodiment corresponds to a pulse-drive signal output circuit, the pulse-width modulated signal Pwmp corresponds to a pulse drive signal, and the duty-designation voltage signal Vd corresponds to a differential signal.

The switching driver 2 is connected to the PWM 1, and receives the pulse-width modulated signal Pwmp as an input from the PWM 1 and connects the input power supply VIN to the LC low-pass filter 3 with a low resistance when the potential of the pulse-width modulated signal Pwmp is high. On the other hand, when the potential of the pulse-width modulated signal Pwmp is low, the switching driver 2 connects a grounded power supply to the LC low-pass filter 3 with a low resistance. That is, the switching driver 2 outputs a switching signal Sw of a pulse waveform on the basis of the pulse-width modulated signal Pwmp. The switching driver 2 according to the present embodiment corresponds to a switching circuit.

The LC low-pass filter 3 is constituted by an inductor and a smoothing capacitor. The inductor has one terminal connected to the switching driver 2 and the other terminal connected to the smoothing capacitor. Accordingly, the LC low-pass filter 3 smooths a supplied potential using the smoothing capacitor to generate the output voltage Vo. That is, the LC low-pass filter 3 converts the switching signal Sw into a DC voltage to output the output voltage Vo. The LC low-pass filter 3 according to the present embodiment corresponds to a smoothing circuit.

The voltage divider 4 divides the output voltage Vo to generate a feedback signal Fb.

The reference voltage source 5 outputs a reference voltage Vref.

The error amplifier 6 has an inverting differential input terminal connected to the voltage divider 4 and a non-inverting differential input terminal connected to the reference voltage source 5. That is, the error amplifier 6 receives the feedback signal Fb as an input to the inverting differential input terminal and the reference voltage Vref as an input to the non-inverting differential input terminal, and amplifies a potential difference therebetween to output an error signal Err.

The PCMP 7 has an input terminal connected to the error amplifier 6 and an output terminal connected to the PWM 1. Accordingly, the PCMP 7 receives the error signal Err as an input and outputs the duty-designation voltage signal Vd. The error amplifier 6 and the PCMP 7 according to the present embodiment correspond to a differential-signal output circuit.

The clock oscillator 8 generates a clock signal Clk. The clock signal Clk is a rectangular-wave signal with a constant cycle where a Hi-pulse width duty is extremely low. A time when the clock signal Clk according to the present embodiment has changed to Low corresponds to a base time.

The generator 9 has an input terminal connected to the clock oscillator 8 and an output terminal connected to the PWM 1. Accordingly, the generator 9 outputs the amplitude modulated signal SawGcmp synchronous with the clock signal Clk and proportional to the input voltage Vi of the input power supply VIN. The generator 9 generates the amplitude modulated signal SawGcmp to cause the interval from the base time of the clock signal Clk to a time point when the duty-designation voltage signal Vd and the amplitude modulated signal SawGcmp have a same value to decrease as the input voltage Vi increases. The low-pass filter 9a is a filter that suppresses time fluctuation of the input voltage Vi. The generator 9 according to the present embodiment corresponds to a pulse-drive signal output circuit and a signal generation circuit.

With this configuration, the voltage of the amplitude modulated signal SawGcmp has a sawtooth waveform that is reset to a low voltage at an instant of rising of the clock signal Clk and thereafter gradually increases. That is, the amplitude of the waveform of the amplitude modulated signal SawGcmp is proportional to the voltage of the input power supply VIN.

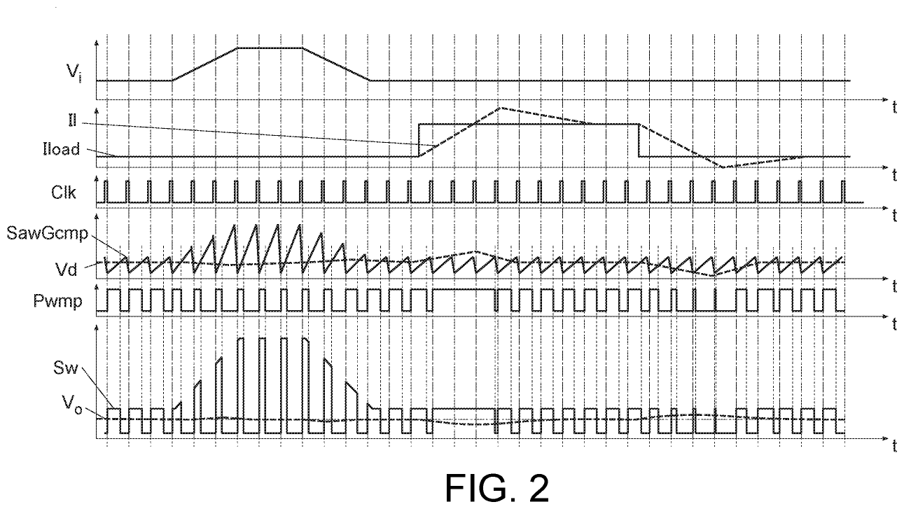

FIG. 2 is a diagram illustrating operation waveforms of the switched-mode power supply according to the first embodiment. The horizontal axis represents a time. The input voltage Vi of the input power supply VIN, a load current Iload shown by a solid line, and an inductor current it shown by a broken line are illustrated in this order from a top part.

In a part below, the clock signal Clk, the amplitude modulated signal SawGcmp shown by a solid line, and the duty-designation voltage signal Vd shown by a broken line are illustrated. The pulse-width modulated signal Pwmp is illustrated in a part below, and the switching signal Sw shown by a solid line and the output voltage Vo shown by a broken line are illustrated in the lowermost part.

In this example, a state is illustrated where the input voltage Vi is initially a normal voltage, subsequently becomes an abnormal high voltage, and then returns to the normal voltage. The load current Iload initially keeps a constant state at a relatively light load, then abruptly changes to a heavy load state, and then abruptly changes again to the light load state. While the inductor current Il increases or decreases to follow the load current Iload at that time, the increasing or decreasing speed has a slope depending on the inductance of the LC low-pass filter 3, the input voltage Vi, and the output voltage Vo and is gentle. The clock signal Clk is pulse signals that become Hi for a short period and are repeated at certain intervals. An instant when the clock signal Clk has changed to Low corresponds to the base time.

The amplitude modulated signal SawGcmp has a characteristic waveform according to the present embodiment. The amplitude modulated signal SawGcmp abruptly changes to a low voltage in periods when the clock signal Clk is Hi. Thereafter, from an instant when the clock signal Clk has changed to Low, the potential of the amplitude modulated signal SawGcmp starts increasing. The slope of the potential increase is constant in proportion to the input voltage Vi. Because the cycle of the clock signal Clk is fixed, the amplitude of the amplitude modulated signal SawGcmp is proportional to the input voltage Vi. At that time, time fluctuation in high frequencies of the input voltage Vi is suppressed by the low-pass filter 9a. Therefore, influences of noise can be avoided and the characteristics of the amplitude modulated signal SawGcmp can be maintained. Particularly the amplitude of the amplitude modulated signal SawGcmp fluctuates according to the magnitude of the input voltage Vi and thus suppression of high frequency components in the input voltage Vi is important to fix the output voltage Vo.

The duty-designation voltage signal Vd is obtained by subtracting the potential of the feedback signal Fb from the reference voltage Vref, amplifying the resultant voltage using the error amplifier 6 to obtain the error signal Err, and further slowing the change speed of the error signal Err using the PCMP 7.

The pulse-width modulated signal Pwmp is Hi when the potential of the amplitude modulated signal SawGcmp is lower than that of the duty-designation voltage signal Vd, and is Low when the potential of the amplitude modulated signal SawGcmp is higher than that of the duty-designation voltage signal Vd. As the input voltage Vi increases, the duration time of Hi of the pulse-width modulated signal Pwmp decreases. That is, the generator 9 generates the amplitude modulated signal SawGcmp to cause the interval from a base time of the clock signal Clk to a time point when the amplitude modulated signal SawGcmp and the voltage signal Vd have a same value, that is, the duration time of Hi of the pulse-width modulated signal Pwmp to be shorter as the input voltage Vi increases.

A switching element (not illustrated) of the switching driver 2 becomes Hi or Low according to the state of the pulse-width modulated signal Pwmp. The switching element at Hi is connected to the input power supply VIN and the switching element at Low is connected to the grounded power supply with low resistances, respectively. The output voltage Vo is output from the switching element of the switching driver 2 via the LC low-pass filter 3.

In this way, the amplitude of the amplitude modulated signal SawGcmp is proportionated to the input voltage Vi. This enables the time when the potential of the amplitude modulated signal SawGcmp is above the potential of the duty-designation voltage signal Vd to be shortened as the input voltage Vi increases. As indicated from this, the time when the input power supply VIN and the switching element of the switching driver 2 are connected with a low resistance decreases as the input voltage Vi increases, so that an operation to keep the output voltage Vo at a constant value can be achieved. That is, the output voltage Vo is kept at a predetermined value on the basis of the amplitude modulated signal SawGcmp and the duty-designation voltage signal Vd.

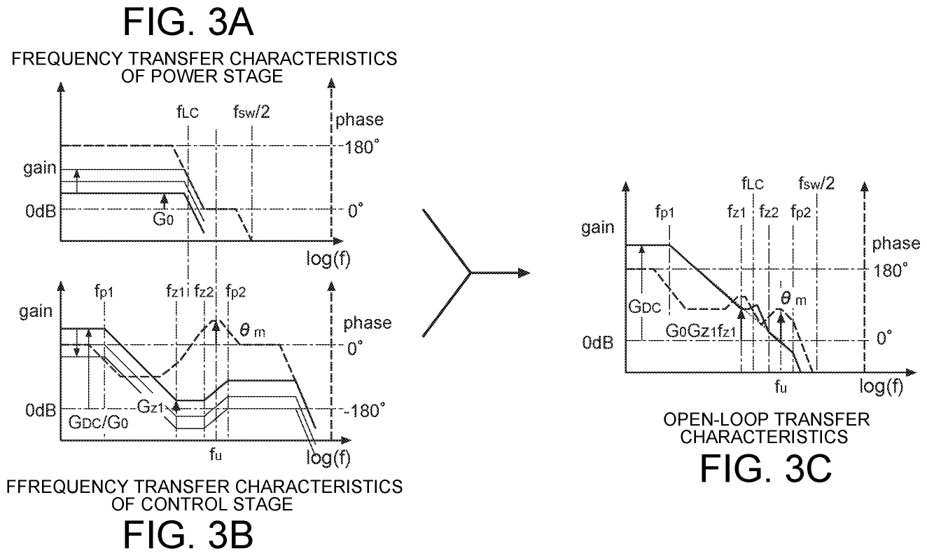

FIGS. 3A to 3C are Bode plots illustrating stability provided by feedback control on the output voltage Vo. FIG. 3A is a diagram illustrating frequency transfer characteristics of a power stage. The frequency transfer characteristics of the power stage represent changes of a sine-wave signal indicating voltage fluctuation v(f) of the output voltage Vo obtained as an output when a sine-wave signal indicating the time ratio of Hi of the pulse-width modulated signal Pwmp, that is, a duty d(f) as an input is supplied.

FIG. 3B is a diagram illustrating frequency transfer characteristics of a control stage. The frequency transfer characteristics of the control stage represent changes of a sine-wave signal indicating a duty d(f) of the pulse-width modulated signal Pwmp obtained as an output when a sine-wave signal indicating the fluctuation v(f) of the output voltage Vo as an input is supplied. FIG. 3C is a diagram illustrating open-loop transfer characteristics. The open-loop transfer characteristics are obtained by synthesizing the frequency transfer characteristics of the power stage and the frequency transfer characteristics of the control stage.

The horizontal axis of each graph represents the frequency of the sine-wave signal logarithmically expressed. The left vertical axis represents the amplitude gain (the multiplying factor) in the dB unit, where amplitude gains are shown by solid lines with respect to a level shown by a dashed-dotted line assumed as 0 dB, that is, factor 1. The right vertical axis represents the phase difference in the angular unit, where a level 0° indicating a same phase as a reference, a level 180° indicating that the phase leads to a reversed phase, and a level−180° indicating that the phase lags to a reversed phase are shown by dashed-dotted lines. The phase difference of the output sine-wave signal with respect to the input sine-wave signal is shown by a broken line.

The frequency transfer characteristics of the power stage illustrated in FIG. 3A are a synthesis of the transfer characteristics of the output driver 2 and the transfer characteristics of the LC low-pass filter 3. The gain is a base gain G0 and constant in a region lower than a cutoff frequency f_{LC} of the LC low-pass filter 3 and decreases in reverse proportion to the square of the frequency in a region higher than the cutoff frequency f_{LC}. The phase difference can be assumed to be almost 0° in a region sufficiently lower than the cutoff frequency f_{LC} (for example, equal to or lower than one-tenth thereof). Meanwhile, a lag occurs as approaching the cutoff frequency f_{LC} and the phase difference of the sine-wave signal of the cutoff frequency f_{LC} is 90°. The phase difference of a sine-wave signal with a frequency ten times as high as (for example, about tenfold of) the cutoff frequency f_{LC} is almost −180°, that is, a reversed phase.

When the frequency f further approaches fsw/2 being a half of the switching frequency, the phase lag rapidly increases. The duty d(f) is a signal in a range from 0 to 1 and the output voltage Vo changes from 0 volt to the input voltage Vi in proportion to the duty d(f). Therefore, the base gain G0 can be represented by an expression 1.

Gₒ=Vᵢ (Expression 1)

The open-loop transfer characteristics illustrated in FIG. 3C indicate characteristics to be aimed for to stabilize the feedback control of the switched-mode power supply. The open-loop transfer characteristics to be aimed for are one-pole transfer characteristics bending from a sufficiently high DC gain G_{DC} at a first-pole frequency fp1, decreasing in reverse proportion to the frequency f of the sine-wave signal, and bending again at a second pole frequency fp2 over a unity gain frequency fu as illustrated in FIG. 3C. Accordingly, the gain characteristics shown by the solid line and the phase characteristics shown by the broken line are set as below.

First, as the gain characteristics to be aimed for, the DC gain G_{DC} in a region where the frequency f is quite low is set to have a large value. As the DC gain G_{DC} is larger, a higher control accuracy on the output voltage Vo is obtained when a feedback control loop is constituted. The DC gain G_{DC} is set to be, for example, larger than 60 dB. In the one-pole transfer characteristics, the product of the first pole frequency fp1 and the DC gain G_{DC} is equal to the unity gain frequency fu where the gain is 0 dB (factor 1). This is represented as follows.

G_{DC}fₚ₁=fᵤ (Expression 2)

The unity gain frequency fu is also called “control bandwidth” and is an index representing the speed of a response to load fluctuation of the feedback control loop. As the control bandwidth fu is higher, the response at a time when the load abruptly changes becomes faster. In the case of a switched-mode power supply, the control bandwidth fu needs to be set to values higher than the cutoff frequency f_{LC} to suppress influences of LC resonance of the LC low-pass filter 3. Meanwhile, the upper limit of the control bandwidth fu is fsw/2 being a half of the switching frequency fsw. If this relation is reversed, the feedback control loop reacts to noise occurring with a switching operation and the output voltage Vo becomes unstable. Therefore, the setting range of the control bandwidth fu is represented by an expression 3.

$${f}_{LC} < {f}_{u} < \frac{{f}_{SW}}{2} \qquad ( Expression 3 )$$

Meanwhile, the phase characteristics to be aimed for are 180° of a reverse phase signal in the region where the frequency f is quite low to execute negative feedback control. The phase is lagged by 45° to become 135° at the first pole frequency fp1 and is lagged by 90° at a frequency about ten times as high as the first pole frequency fp1.

The phase characteristics temporarily remain at 90° in a higher frequency region than the frequency ten times as high as the first pole frequency fp1. The phase difference lags to 180° at the LC low-pass filter frequency f_{LC} being a higher frequency than the frequency ten times as high as the first pole frequency fp1. The phase difference lags to 270° at a frequency ten times as high as the LC low-pass filter frequency f_{LC}. In order to prevent these lags, a first zero frequency fz1 and a second zero frequency fz2 are arranged with the LC low-pass filter frequency f_{LC} sandwiched therebetween. Accordingly, the phase difference keeps substantially 90° while slightly increasing or decreasing. When the frequency exceeds the unity gain frequency fu to approach the switching frequency fsw, the phase rapidly lags and the phase difference falls below 0° at fsw/2 being a half of the switching frequency fsw.

An important index indicating the stability of the feedback control is a phase margin θm. The phase margin θm is a phase difference at the unity gain frequency fu. The feedback control is determined to be unstable when the phase difference is equal to or smaller than 45°. When the phase margin θm is equal to or smaller than 45°, the output vibrates several times to be stabilized at a setting value with respect to abrupt fluctuation of the load. When the phase margin θm falls below 0°, the output oscillates. The time required to reach a stable state is shortest when the phase margin θm is 60° while there are some overshoots.

In this way, when the phase margin θm is 72°, overshoots disappear, the response speed becomes fast, and ideal control is obtained. When the phase margin θm exceeds 90°, the response is evaluated to be slow while the feedback control is stable. In order to summarize the forgoing, one-pole transfer characteristics are to be aimed for, where the DC gain G_{DC} is set to be sufficiently large, for example, with a target of 60 dB, the control bandwidth fu is set to an intermediate value between the cutoff frequency f_{LC} of the LC low-pass filter 3 and fsw/2 being a half of the switching frequency fsw, and the phase margin θm is kept to be equal to or higher than 45° with a target of 72°.

Accordingly, to acquire the open-loop transfer characteristics illustrated in FIG. 3C, the PCMP 7 (FIG. 1) that realizes the frequency transfer characteristics of the control stage illustrated in FIG. 3B with respect to the frequency transfer characteristics of the power stage illustrated in FIG. 3A is designed. First, a gain Gamp of the error amplifier 6 is determined to acquire a sufficiently large DC gain G_{DC} being a first condition. Because the frequency transfer characteristics of the power stage have the base gain G0, the relation with the gain Gamp is represented by an expression 4.

$${G}_{amp} = \frac{{G}_{D C}}{{G}_{0}} \qquad ( Expression 4 )$$

When a differential amplifier is constituted using a MOS transistor, it is easy to acquire the gain Gamp equal to or larger than 60 dB. However, the gain Gamp and the first pole frequency fp1 are affected by characteristic fluctuation of the MOS transistor and therefore greatly fluctuate due to variation of the temperature, the power-supply voltage, and the manufacturing process. Therefore, instead of setting the gain Gamp and the first pole frequency fp1, a zero point (differential property) is added to the PCMP 7 and a first zero frequency fz1 thereof and a gain Gz1 at the first zero frequency fz1 are set. The first zero frequency fz1 and the first zero gain Gz1 can be set by a resistive element and a capacitive element that constitute the PCMP 7. The resistive element and the capacitive element have an advantage of being less likely to be affected by variation of the temperature, the power-supply voltage, and the manufacturing process.

When the first zero frequency fz1 is set to be lower than the frequency f_{LC}, the product of the first zero frequency fz1 and the first zero gain Gz1 is equal to the unity gain frequency fu and an expression 5 is obtained.

fᵤ=G_{DC}fₚ₁=G₀G_{z1}f_{z1}

where f_{z1}<f_{LC} Expression (5)

Because the base gain G0 is known from the expression 1, the unity gain frequency, that is, the control bandwidth fu can be determined by setting the product of the first zero frequency fz1 and the first zero gain Gz1 added by the PCMP 7. Accordingly, a second condition that the control bandwidth fu is set to a value about intermediate between the cutoff frequency f_{LC} and fsw/2 being a half of the switching frequency fsw can also be met.

Finally, a third condition that the phase margin θm is kept to be equal to or higher than 45° with a target of 72° is sought to be met. The control bandwidth fu is set to a value sufficiently higher than the cutoff frequency f_{LC}. Therefore, as illustrated in FIG. 3A, the phase margin θm of the output stage is basically substantially 0°.

Further, as illustrated in FIG. 3B, the first pole frequency fp1 and the first zero frequency fz1 sufficiently lower than the control bandwidth fu are set in the PCMP 7. Because the phase difference lagged by 90° due to the first pole frequency fp1 is returned again to 0° due to the first zero frequency fz1, a quite unstable state is obtained if a feedback control circuit is constituted in this situation.

In order to solve this problem, the phase is compensated by adding a second zero point (differential property) to the PCMP 7. At the same time, the second pole frequency fp2 is arranged to sandwich the control bandwidth fu with a second zero frequency fz2 exactly in the middle. The phase having led at the second zero frequency fz2 is lagged again at the second pole frequency fp2 and thus the phase margin θm is represented by an expression 6.

$${θ}_{m} = {tan}^{- 1} ( \frac{\sqrt{\frac{{f}_{p 2}}{{f}_{z 2}}} - \sqrt{\frac{{f}_{z 2}}{{f}_{p 2}}}}{2} ) \\ where {f}_{u} = \sqrt{{f}_{z 2} {f}_{p 2}} \qquad ( Expression 6 )$$

When the expression 6 is solved, the second zero frequency fz2 and the second pole frequency fp2 for setting the phase margin θm to 72° (θm=72°) can be represented by an expression 7 and an expression 8, respectively.

$$\begin{matrix}{f}_{z 2} = {f}_{u} \sqrt{\frac{1 - sin {θ}_{m}}{1 + sin {θ}_{m}}} & ( Expression 7 ) \\ {f}_{z 2} = {f}_{u} \sqrt{\frac{1 + sin {θ}_{m}}{1 - sin {θ}_{m}}} & ( Expression 8 )\end{matrix}$$

In this way, an output stage having the frequency transfer characteristics of the power stage illustrated in FIG. 3A and a control stage having the frequency transfer characteristics of the control stage illustrated in FIG. 3B are connected to each other to obtain the open-loop transfer characteristics illustrated in FIG. 3C, whereby the stability of the feedback loop control can be provided. The output voltage Vo is defined by the reference voltage Vref output from the reference voltage source 5 and a division ratio Ho of the voltage divider 4 and is represented by an expression 9. That is, the output voltage Vo is independent of the input voltage Vi. These characteristics are preferable for a constant-voltage power supply.

Vo=Vref/Hₒ (Expression 9)

Referring again to the expression 1, it indicates that the base gain G0 increases in proportion to the input voltage Vi. This is shown by thin solid lines in the frequency transfer characteristics of the power stage illustrated in FIG. 3A. When the expression 1 and the expression 5 are combined, an expression 10 is obtained.

fᵤ=VᵢG_{z1}f_{z1} (Expression 10)

The characteristics that the control bandwidth fu increases in proportion to the input voltage Vi are not preferable for a constant-voltage power supply. Therefore, in the present embodiment, a voltage increase rate dVsaw/dt of the amplitude modulated signal SawGcmp is adjusted by the generator 9 to be proportional to the input voltage Vi as represented by an expression 11.

$$\frac{{dV}_{saw}}{dt} = {M}_{saw} {V}_{i} \qquad ( Expression 11 )$$

The dependency of the control bandwidth fu on the input voltage Vi is compensated by a proportionality coefficient Msaw, which is obtained by dividing the voltage increase rate dVsaw/dt of the signal SawGcmp by the input voltage Vi, and fluctuation of the control bandwidth fu is suppressed as represented by an expression 12.

$${f}_{u} = \frac{{G}_{z 1} {f}_{z 1}}{{M}_{saw}} \qquad ( Expression 12 )$$

A conventional acceptable range of the input voltage Vi is, for example, 6 volts to 12 volts and the ratio between the lower limit and the upper limit is limited to about 1:2. However, an acceptable range of the input voltage Vi used for a self-driving device or the like is, for example, 4 volts to 40 volts and the ratio between the lower limit and the upper limit is so large as to reach 1:10. This provides compensation that enables a self-driving operation to be continued even if the input power supply VIN is broken.

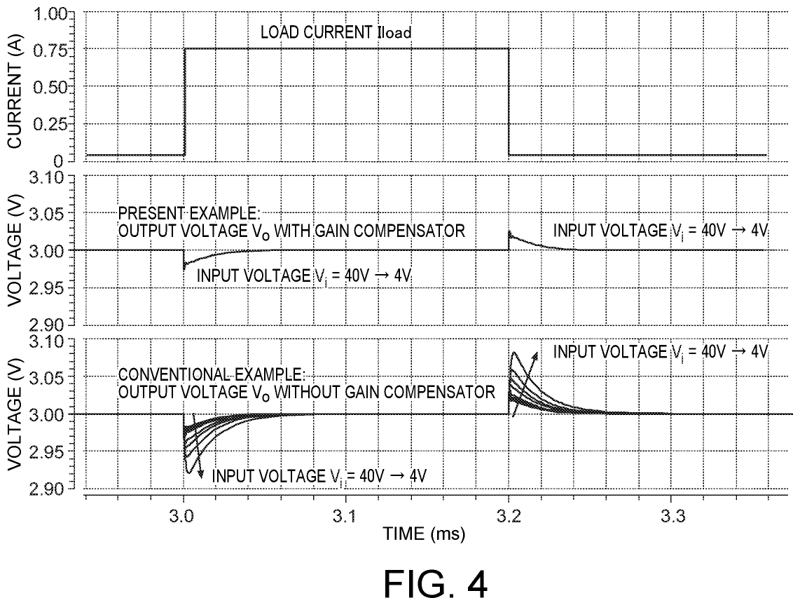

FIG. 4 are operation waveform diagrams illustrating an effect example of the switched-mode power supply. A diagram in the top part illustrates temporal changes of the load current Iload, a diagram in the middle part illustrates temporal changes of the output voltage Vo, and a diagram in the bottom part illustrates temporal changes of the output voltage Vo in a conventional example. The vertical axes represent the load current Iload, the output voltage Vo, and the output voltage Vo in a conventional example, respectively, and the horizontal axis represents a time. The diagrams in the middle and bottom parts illustrate examples in which nine different voltages in a range from 4 volts to 40 volts are used as the input voltage Vi. That is, the diagrams in the middle and bottom parts illustrate nine waveforms of the output voltages Vo in a case where the input voltage Vi is changed from 4 volts to 40 volts to be input to the switched-mode power supply 100.

While being initially constant at a low value of 50 milliamperes, the load current Iload increases to 750 milliamperes at 3.0 milliseconds in a step manner. Thereafter, the load current Iload is constant at the high value of 750 milliamperes until 3.2 milliseconds and returns again to the low value of 50 milliamperes in a step manner at 3.2 milliseconds.

Although the output voltage Vo fluctuates by about 20 millivolts due to each of abrupt changes of the load current Iload, the voltage is returned to 3 volts by an action of the feedback control circuit. While nine waveforms of the output voltage Vo are illustrated, the output voltage Vo shows such an exactly same reaction that the nine waveforms appear to be one waveform. It is thus understood that influences of fluctuation of the input voltage Vi are canceled by the action of the gain-compensating generator 9.

On the other hand, in a conventional switched-mode power supply having no gain compensating function, the load-fluctuation response characteristics of the output voltage Vo are affected by the input voltage Vi. When the input voltage Vi has a high value of 40 volts, the load-fluctuation response characteristics of the output voltage Vo are satisfactory and the voltage fluctuation is suppressed to about 20 millivolts. However, the load-fluctuation response characteristics of the output voltage Vo deteriorate as the input voltage Vi decreases. When the input voltage Vi is 4 volts, the fluctuation amount of the output voltage Vo reaches 80 millivolts.

According to the present embodiment, the amplitude of the amplitude modulated signal SawGcmp output from the generator 9 is set to be proportional to the input voltage Vi. Accordingly, as the input voltage Vi increases, the time when the potential of the amplitude modulated signal SawGcmp is above the duty-designation voltage signal Vd decreases, and the time when the input power supply VIN is connected to the switching element of the switching driver 2 with a low resistance reduces, so that an effect of keeping the output voltage Vo at a constant value can be achieved. In this case, when a low-pass filter is applied to the input power supply VIN, the output voltage Vo can be more stably kept at a constant value.

### SECOND EMBODIMENT

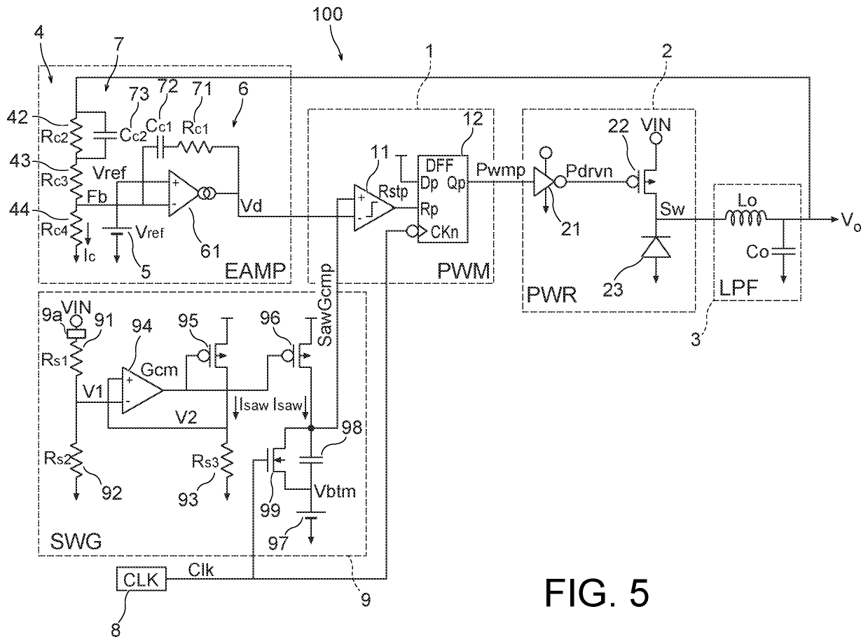

FIG. 5 is a detailed configuration example of a switched-mode power supply according to a second embodiment. In the second embodiment, a detailed internal configuration of the switched-mode power supply according to the first embodiment are described. Like constituent elements as those in the first embodiment are denoted by like reference numerals and explanations thereof are omitted.

The switching driver 2 includes a pre-driver 21, a P-type MOS transistor 22, and an asynchronous power diode 23. The pre-driver 21 has an input terminal connected to an output terminal of the PWM 1 and an output terminal connected to a gate of the transistor 22. The pre-driver 21 inverts the pulse-width modulated signal Pwmp to output a drive signal PDRVn to the gate of the transistor 22. At that time, the level shift is performed to obtain the input voltage Vi of the input power supply VIN when the drive signal PDRVn is Low and to obtain a potential lower by several volts than the input voltage Vi when the drive signal PDRVn is Hi.

The transistor 22 has a source terminal connected to the input power supply VIN, a drain terminal connected to the LC low-pass filter 3 and a cathode terminal of the diode 23, and the gate terminal connected to the output terminal of the pre-driver 21. The transistor 22 has a low resistance between the source terminal and the drain terminal when the drive signal PDRVn input to the gate terminal is Low, that is, when the potential of the gate terminal is Low and has a high resistance between the source terminal and the drain terminal when the drive signal PDRVn is Hi, that is, when the potential of the gate terminal is Hi.

The diode 23 has an anode terminal connected to a grounded power supply and the cathode terminal connected to the drain terminal of the transistor 22 and the LC low-pass filter 3. The diode 23 has a low resistance between the cathode terminal and the anode terminal when the cathode terminal has a lower potential than the anode terminal, and has a high resistance between the cathode terminal and the anode terminal when the cathode terminal conversely has a higher potential than the anode terminal.

The LC low-pass filter 3 is a low-pass filter constituted by an inductor with an inductance Lo and a capacitor with a capacitance Co. The drain terminal of the transistor 22 and the cathode terminal of the diode 23 are connected to an input terminal of the LC low-pass filter 3 and the output voltage Vo is output from an output terminal thereof. The LC low-pass filter 3 smooths the switching signal Sw that changes rectangularly between the potential of the input power supply VIN and the potential of the grounded power supply to output the output voltage Vo at a constant value. The cutoff frequency f_{LC} of the LC low-pass filter 3 is set to a value smaller than the switching frequency fsw by about double digits to meet the expression 3 in the first embodiment. The cutoff frequency f_{LC} can be set as represented by an expression 13.

$${f}_{LC} = \frac{1}{2 π \sqrt{{L}_{o} {C}_{o}}} \qquad ( Expression 13 )$$

The switching driver 2 and the LC low-pass filter 3 constitutes a power stage PWR of the switched-mode power supply. The power stage PWR operates as a voltage source that receives power from the input power supply VIN and supplies power to the output voltage Vo. The output voltage Vo is controlled according to a ratio (duty) D of Hi in the pulse-width modulated signal Pwmp with respect to the cycle of the clock signal Clk as represented by an expression 14.

Vₒ=D·Vᵢ (Expression 14)

A transfer gain of a small amplitude signal from the input duty D of the power stage PWR to the output voltage Vo, that is, the base gain G0 in a frequency region sufficiently lower than the cutoff frequency f_{LC} of the LC low-pass filter 3 can be obtained by differentiating the output voltage Vo with the duty D as represented by an expression 15. Therefore, the base gain G0 is equal to the input voltage Vi. This is same as the expression 1 in the first embodiment.

$${G}_{o} = \frac{{dV}_{o}}{dD} = {V}_{i} \qquad ( Expression 15 )$$

The voltage divider 4 has an Rc2 resistive element 42, an Rc3 resistive element 43, and an Rc4 resistive element 44 connected in series, and a Cc2 capacitor 73. The output terminal of the LC low-pass filter 3 is connected to one terminal of the resistive element 42, the grounded power supply is connected to one terminal of the resistive element 44, and an inverting input terminal of a current amplifier 61 is connected to a connection point between the resistive element 43 and the resistive element 44. The capacitor 73 is connected in parallel to the resistive element 42. The voltage division ratio Ho of the voltage divider 4 is defined on the basis of resistances Rc2, Rc3, and Rc4 of the resistive elements 42, 43, and 44 as represented by an expression 16. That is, a divided voltage of the voltage divider 4 obtained by multiplying the output voltage Vo by the voltage division ratio Ho is input to the inverting input terminal of the current amplifier 61 as the feedback signal Fb.

$${H}_{o} = \frac{{R}_{c 4}}{{R}_{c 2} + {R}_{c 3} + {R}_{c 4}} \qquad ( Expression 16 )$$

A current I_{FB} flowing in the voltage divider 4 is represented by an expression 17 on the basis of the output voltage Vo and the three resistances Rc2, Rc3, and Rc4.

$${I}_{FB} = \frac{{V}_{o}}{{R}_{c 2} + {R}_{c 3} + {R}_{c 4}} \qquad ( Expression 17 )$$

It is preferable to set the current I_{FB} to a small value considering the power efficiency at the time of a light load. However, if the current I_{FB} is set to a too small value, influences of noise, a parasitic element, a leakage current, or variation of an element constant become large. Therefore, the current I_{FB} is set considering trade-off between the power efficiency and the accuracy of the output voltage. However, when the switched-mode power supply according to the present embodiment is mounted as an integrated circuit, noise, a parasitic element, a leakage current, or variation of an element constant can be suppressed and it is appropriate to set the current I_{FB} to about 1 microampere to reduce the chip area.

The reference voltage source 5 outputs the reference voltage Vref. While the reference voltage source 5 is expressed as an ideal voltage source in FIG. 5, circuits of various configurations such as a bandgap reference circuit are practically used. As represented by an expression 18, the voltage Ho of the feedback signal Fb and the reference voltage Vref are controlled by the feedback control loop to have a same potential.

$${V}_{0} = \frac{{V}_{ref}}{{H}_{o}} \qquad ( Expression 18 )$$

The error amplifier 6 is constituted by the current amplifier 61. A node between the resistive element 43 and the resistive element 44 is connected to the inverting input terminal of the current amplifier 61, the reference voltage source 5 is connected to a non-inverting input terminal thereof, and an inverting input terminal of a voltage comparator 11 is connected to an output terminal thereof. Accordingly, the current amplifier 61 amplifies a potential difference of the feedback signal Fb from the reference voltage Vref and outputs the duty-designation voltage signal Vd on the basis of a current proportional to the potential difference.

The PCMP 7 is constituted by a resistive element 71, a capacitor 72, and the capacitor 73 connected in parallel to the resistive element 42. The resistive element 71 and the capacitor 72 are connected in series. One end of the PCMP 7 on the side of the capacitor 72 is connected to the inverting input terminal of the current amplifier 61, and the other end thereof is connected to the output terminal of the current amplifier 61.

Accordingly, the voltage divider 4, the reference voltage source 5, the error amplifier 6, and the PCMP 7 operate as an error amplifier EAMP in a broad sense. The error amplifier EAMP receives the output voltage Vo as an input and charges or discharges the duty-designation voltage signal Vd with an error amplifier current I_{EMAP} represented by an expression 19.

$${I}_{EAMP} = {g}_{amp} ( \frac{{V}_{ref}}{{H}_{o}} - {V}_{o} ) \qquad ( Expression 19 )$$

In this expression, gamp denotes a mutual conductance indicating an amplification factor of the current amplifier 61. While the mutual conductance gamp implemented by an integrated circuit is about several tens of microsiemens (μS), an internal output resistance roamp of the current amplifier 61 is several hundreds of megohms (Mohm) and is quite large, and an output capacitance Coₐₘₚ is lower than one picofarad (pF) and is small. Therefore, a large value equal to or larger than 60 dB can be obtained as a voltage amplification factor G_{EAMP} of the error amplifier EAMP.

However, because being greatly influenced by variation of the power-supply voltage, the temperature, and the manufacturing process, the mutual conductance gamp, the gamp internal output resistance roamp, and the gamp output capacitance Coₐₘₚ are difficult to uniquely define. Accordingly, the voltage amplification factor G_{EAMP} is set as represented by an expression 20 on the basis of the first zero frequency fz1 and the first zero gain Gz1 of the PCMP 7.

G_{EAMP}=f_{z1}G_{z1} (Expression 20)

The first zero frequency fz1 and the first zero gain Gz1 can be set on the basis of a capacitance Cc1 and resistances Rc1, Rc2, and Rc3 as represented by expressions 21 and 22, respectively.

$$\begin{matrix}{f}_{z 1} = \frac{1}{2 π {R}_{c 1} {C}_{c 1}} & ( Expression 21 ) \\ {G}_{z 1} = \frac{{R}_{c 1}}{{R}_{c 2} + {R}_{c 3}} & ( Expression 22 )\end{matrix}$$

As described above, ideal control where there is no overshoot and the response speed is fast is achieved when the phase margin θm in the control bandwidth fu represented by the expressions 7 and 8 in the first embodiment is 72°. Accordingly, the second zero frequency fz2 and the second pole frequency fp2 are set to obtain 72° as the phase margin θm in the control bandwidth fu. The second zero frequency fz2 and the second pole frequency fp2 are set on the basis of a capacitance Cc2 and the resistances Rc2 and Rc3 as represented by expressions 23 and 24, respectively.

$$\begin{matrix}{f}_{z 2} = \frac{1}{2 π {R}_{c 2} {C}_{c 2}} & ( Expression 23 ) \\ {f}_{p 2} = \frac{1}{2 π ( \frac{{R}_{c 2} {R}_{c 3}}{{R}_{c 2} + {R}_{c 3}} ) {C}_{c 2}} & ( Expression 24 )\end{matrix}$$

The clock oscillator 8 is a clock circuit that generates the clock signal Clk in which Hi and Low are repeated at a substantially constant frequency fsw. The clock oscillator 8 can have any configuration.

However, the clock signal Clk in the present embodiment has a pulse wave in which the period of Hi is shorter than the period of Low. A relation in the size among the oscillation frequency fsw, the control bandwidth fu, and the cutoff frequency f_{LC} needs to be set as represented by an expression 25.

$${f}_{LC} < {f}_{u} < \frac{{f}_{SW}}{2} \qquad ( Expression 25 )$$

Setting conditions of the three frequencies represented by the expression 25 are same as those of the expression 3. The oscillation frequency fsw and the cutoff frequency f_{LC} are kept substantially constant regardless of the input voltage Vi. Meanwhile, the control bandwidth fu is the product of the base gain G0, the first zero gain Gz1, and the first zero frequency fz1 as represented by the expression 5. Because the base gain G0 fluctuates in proportion to the input voltage Vi as represented by the expression 15, the control bandwidth fu fluctuates similarly.

In use conditions of a conventional switched-mode power supply, the ratio between the upper limit and the lower limit of the input voltage is limited to about 2:1 and thus no problems occur if the control bandwidth fu fluctuates according to the input voltage Vi. However, in the switched-mode power supply for automatic control, it is not uncommon that the ratio between the upper limit and the lower limit of the input voltage Vi reaches 10:1 for the safety. Accordingly, if the acceptable range of the input voltage Vi becomes wide, the condition represented by the expression 25 cannot be met. In contrast thereto, the generator 9 according to the present embodiment has a gain compensating function to compensate this input voltage dependency and therefore the output voltage Vo is kept at a predetermined value even if the ratio between the upper limit and the lower limit of the input voltage Vi reaches 10:1.

The generator 9 includes a resistive element 91 with a resistance R_{S1}, a resistive element 92 with a resistance R_{S2}, a resistive element 93 with a resistance R_{S3}, a differential amplifier 94, current-mirror PMOS transistors 95 and 96, a bottom voltage source 97, a voltage increase-rate adjusting capacitor 98 with a capacitance Csaw, and a reset NMOS transistor 99. The resistive elements 91 and 92 are connected in series between the input power supply VIN and the grounded power supply and divides the input voltage Vi. An intermediate node between the resistive elements 91 and 92 is connected to an inverting terminal of the differential amplifier 94. Accordingly, a divided voltage V1 is applied to the inverting terminal of the differential amplifier 94. An output terminal of the differential amplifier 94 is connected to gate terminals of the transistors 95 and 96.

The resistive element 93 has one terminal connected to a drain terminal of the transistor 95, and the other terminal connected to the grounded power supply. A connection node between the drain terminal of the transistor 95 and the resistive element 93 is connected to a non-inverting terminal of the differential amplifier 94. Accordingly, a voltage V2 at the connection node between the drain terminal of the transistor 95 and the resistive element 93 is applied to the non-inverting terminal of the differential amplifier 94. With the differential amplifier 94, a gate drive signal Gcm indicating a difference voltage between the divided voltage V1 and the voltage V2 is applied to the gate terminals of the transistors 95 and 96.

The transistors 95 and 96 are elements having equal electrical characteristics. A control-circuit power supply is connected to source terminals of the both transistors 95 and 96 and the gate drive signal Gcm is supplied to the gate terminals. The voltage V2 is supplied to the drain terminal of the transistor 95. Meanwhile, a drain terminal of the transistor 96 is connected to a source terminal of the transistor 99 and is supplied with the amplitude modulated signal SawGcmp.

The bottom voltage source 97 generates a bottom voltage signal Vbtm serving as a criterion on a low potential side of the amplitude modulated signal SawGcmp. While being illustrated as an ideal voltage source in FIG. 5, the bottom voltage source 97 can be a constant voltage source with any configuration.

The bottom voltage source 97 and the source terminal of the transistor 99 are connected to one terminal of the voltage increase-rate adjusting capacitor 98. The transistor 99 is supplied with the bottom voltage signal Vbtm at the source terminal and is supplied with the amplitude modulated signal SawGcmp at the drain terminal. The clock signal Clk is supplied to a gate terminal of the transistor 99.

The generator 9 adjusts a rising voltage speed dVsaw/dt of the signal SawGcmp according to the input voltage Vi to compensate small-signal transfer gain characteristics. The input voltage Vi is divided to obtain the divided voltage V1, and the voltage V2 at the same potential is applied to the resistive element 93 by the differential amplifier 94. A current Isaw flowing in the resistive element 93 is reproduced using the transistors 95 and 96 and the adjusting capacitor 98 with the capacitance Csaw is charged with the current Isaw having the same magnitude. Accordingly, the rising voltage speed dVsaw/dt of the signal SawGcmp proportional to the input voltage Vi as represented by an expression 26 is obtained. Because the clock frequency fsw is constant, the signal SawGcmp becomes an amplitude modulated signal having an amplitude proportional to the input voltage Vi.

$$\frac{{dV}_{saw}}{dt} = {V}_{i} \frac{{R}_{s 2}}{{R}_{s 1} + {R}_{s 2}} \cdot \frac{1}{{R}_{s 3}} \cdot \frac{1}{{C}_{saw}} \qquad ( Expression 26 )$$

The PWM 1 includes a voltage comparator 11 and a D flip-flop 12. The voltage comparator 11 receives the duty-designation voltage signal Vd as an input to an inverting input terminal, receives the amplitude modulated signal SawGcmp as an input to a non-inverting input terminal, and outputs a reset signal Rstp from an output terminal. The voltage comparator 11 outputs the reset signal Rstp at Hi when the potential of the amplitude modulated signal SawGcmp is higher than the potential of the duty-designation voltage signal Vd, and outputs the reset signal Rstp at Low in other cases.

The clock signal Clk is input to an inverting-clock input terminal CKn of the D flip-flop 12, an always-Hi signal is input to a data input terminal Dp thereof, the reset signal Rstp is input to a reset terminal Rp thereof, and the pulse-width modulated signal Pwmp is output from a data output terminal Qp thereof.

The D flip-flop 12 takes in the always-Hi signal from the data input terminal Dp at an instant when the clock signal Clk changes to Low, retains the signal therein, and simultaneously outputs the pulse-width modulated signal Pwmp at Hi from the data output terminal Qp. When the reset signal Rstp is Hi, the D flip-flop 12 resets the internal signal to Low regardless of inputs to the inverting clock terminal CKn and the data input terminal Dp and outputs the pulse-width modulated signal Pwmp at Low from the data output terminal Qp.

The amplitude modulated signal SawGcmp is discharged by the transistor 99 to become the bottom voltage signal Vbtm in a period when the clock signal Clk is Hi. When the clock signal Clk becomes Low, the potential of the amplitude modulated signal SawGcmp starts increasing. At that instant, the D flip-flop 12 takes in the always-Hi signal input to the data input terminal Dp and the pulse-width modulated signal Pwmp becomes Hi.

Thereafter, at an instant when the amplitude modulated signal SawGcmp becomes higher than the duty-designation voltage signal Vd, the D flip-flop 12 is reset upon receipt of the reset signal Rstp, and the pulse-width modulated signal Pwmp becomes Low. In this way, the time ratio of Hi in the pulse-width modulated signal Pwmp, that is, the duty D is controlled by the duty-designation voltage signal Vd as represented by an expression 27.

$$D = ( {V}_{d} - {V}_{btm} ) / \frac{{dV}_{SAW}}{dt} / \frac{1}{{f}_{SW}} \qquad ( Expression 27 )$$

However, the duty-designation voltage signal Vd is controlled by the feedback control loop to cause the output voltage Vo to maintain the expression 18 and thus is not uniquely defined.

Therefore, both sides of the expression 27 are differentiated with the output voltage Vo to obtain an expression 28. In this example, a small-signal voltage amplification factor dVd/dVo with respect to the output voltage Vo as an input and the duty-designation voltage signal Vd as an output is the voltage amplification factor G_{EAMP} of the error amplifier EAMP. The voltage amplification factor G_{EAMP} is set on the basis of the first zero frequency fz1 and the first zero gain Gz1 of the phase compensator 7 as represented by the expression 20.

$$\begin{matrix}\frac{dD}{{dV}_{o}} = \frac{{dV}_{d}}{{dV}_{o}} / \frac{{dV}_{SAW}}{dt} / \frac{1}{{f}_{SW}} \\ = {f}_{z 1} {G}_{z 1} {f}_{SW} {R}_{c 3} {C}_{SAW} \cdot \frac{{R}_{s 1} + {R}_{s 2}}{{R}_{s 2}} \cdot \frac{1}{{V}_{i}}\end{matrix} \qquad ( Expression 28 )$$

In the expression 28, (dD/dVo) is a gain of the control stage. By calculating the product of (dD/dVo) and the gain (dVo/dD) of the output stage represented by the expression 15, an expression 29 representing the control bandwidth fu of the open-loop transfer characteristics is obtained.

That is, the dependency of the input voltage Vi is canceled from the control bandwidth fu.

$$\begin{matrix}{f}_{u} = ( \frac{dD}{{dV}_{o}} ) \cdot ( \frac{{dV}_{o}}{dD} ) \\ = {f}_{z 1} {G}_{z 1} {f}_{SW} {R}_{c 3} {C}_{SAW} \cdot \frac{{R}_{s 1} + {R}_{s 2}}{{R}_{s 2}}\end{matrix} \qquad ( Expression 29 )$$

As explained above, according to the present embodiment, the output voltage Vo, the control bandwidth fu thereof, and the phase margin θm can be set by circuit constants of the reference voltage Vref, the switching frequency fsw, the three capacitances Cc1, Cc2, and Csaw, and the seven resistances Rc1, Rc2, Rc3, Rc4, Rs1, Rs2, and Rs3. Because these circuit constants are less affected by variation of the voltage, the temperature, and the process, a switched-mode power supply providing a more stable output voltage can be designed. Therefore, a switched-mode power supply having fast load response characteristics in a wide acceptable voltage range that is available for, for example, self-driving can be provided.

### THIRD EMBODIMENT

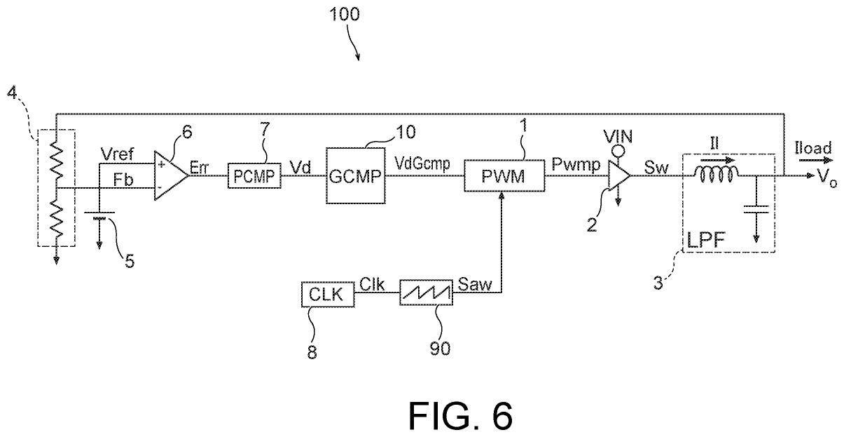

A switched-mode power supply according to a third embodiment is different from that according to the first embodiment in that the gain of an open loop of feedback control is adjusted by a gain compensator 10 (hereinafter, GCMP 10) inserted between the PCMP 7 and the PWM 1. Different points from the switched-mode power supply according to the first embodiment are explained below. FIG. 6 is a diagram illustrating a configuration example of the switched-mode power supply according to the third embodiment.

In the present embodiment, a normal generator 90 is used instead of the gain-compensating generator 9 (FIG. 1). The GCMP 10 converts the voltage of the duty-designation voltage signal Vd into a gain-compensated duty-designation voltage signal VdGcmp according to an expression 30 and outputs the signal VdGcmp. That is, the GCMP 10 multiplies the duty-designation voltage signal Vd by an exponent and outputs the gain-compensated duty-designation voltage signal VdGcmp. The generator 90 outputs an amplitude modulated signal Saw. The GCMP 10 corresponds to a signal generation circuit and the generator 90 corresponds to a signal output circuit. The error amplifier 6, the PCMP 7, and the GCMP 10 correspond to a differential-signal output circuit.

$${V}_{dGcmp} = {V}_{btm} + ( {V}_{top} - {V}_{btm} ) \cdot {e}^{C \cdot \frac{{V}_{d} - {V}_{top}}{{V}_{top} - {V}_{btm}}} \qquad ( Expression 30 )$$

In the expression 30, Vd denotes the voltage of the duty-designation voltage signal Vd and VdGcmp denotes the voltage of the gain-compensated duty-designation voltage signal VdGcmp. Further, Vbtm denotes a lowest voltage of the amplitude modulated signal Saw and Vtop denotes a highest voltage thereof.

C is any constant and is set to a value from about 3 to 5. However, as C is set to a larger value, the compensation ratio of the small-signal transfer gain is increased and the output voltage Vo is more likely to be affected by noise when the input voltage Vi is low. Therefore, it is preferable that C is set to as small a value as possible. However, if the value of C is too small, pulses with a small duty are not output. In order to solve this problem, the constant C is set to enable a minimum voltage Vomin of the output power supply to be output when the input power supply VIN is at an allowable maximum voltage Vimax.

$$C = log \frac{{V}_{amin}}{{V}_{imax}} \qquad ( Expression 31 )$$

For example, when the input power supply VIN at the allowable maximum voltage Vimax is 40 volts, the constant C is set to a value larger than log(40V/0.5V)=4.38 to enable the minimum voltage Vomin=0.5 volts of the output power supply to be stably output.

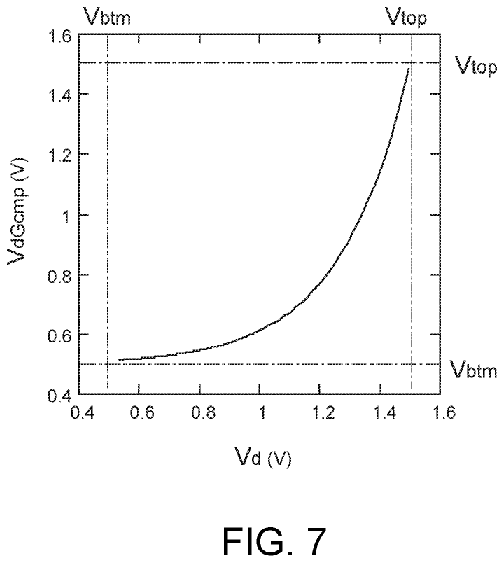

FIG. 7 is a diagram illustrating input/output characteristics of the GCMP 10. The horizontal axis represents the duty-designation voltage signal Vd and the vertical axis represents the gain-compensated duty-designation voltage signal VdGcmp. In this example, the lowest voltage Vbtm of the signal Saw is set to 0.5 volts, the highest voltage Vtop of the signal Saw is set to 1.5 volts, and the constant C is set to 4.38. As illustrated, the gain-compensated duty-designation voltage signal VdGcmp with respect to the duty-designation voltage signal Vd of the GCMP 10 transitions according to a voltage transition curve being convex downward. That is, the GCMP 10 converts the duty-designation voltage signal Vd into the gain-compensated duty-designation voltage signal VdGcmp on the basis of a curve having input/output characteristics being convex downward. The curve that has input/output characteristics being convex can be expressed by an exponent function. The duty-designation voltage signal Vd according to the present embodiment corresponds to a differential signal.

When the gain-compensated duty-designation voltage signal VdGcmp is differentiated with the duty-designation voltage signal Vd to obtain a slope dVdGcmp/dVd, the slope can also be expressed by an exponent function as represented by an expression 32. The slope dVdGcmp/dVd is a compensation ratio Gcmp of the small-signal transfer gain.

$${G}_{cmp} = \frac{{dV}_{dGcmp}}{{dV}_{d}} = C \cdot {e}^{C \cdot \frac{{V}_{d} - {V}_{top}}{{V}_{top} - {V}_{btm}}} \qquad ( Expression 32 )$$

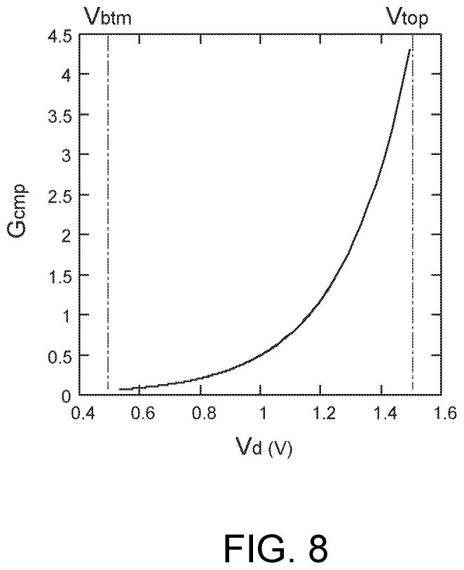

FIG. 8 is a diagram illustrating a gain compensation ratio of the GCMP 10. The horizontal axis represents the duty-designation voltage signal Vd and the vertical axis represents the gain compensation ratio Gcmp of the gain-compensated duty-designation voltage signal VdGcmp. The gain-compensated duty-designation voltage signal VdGcmp has a voltage proportional to the ratio of the output voltage Vo to the input voltage Vi due to the action of the feedback control loop as represented by an expression 33.

$${V}_{dGcmp} = {V}_{btm} + ( {V}_{top} - {V}_{btm} ) \cdot \frac{{V}_{o}}{{V}_{i}} \qquad ( Expression 33 )$$

From the expressions 30 and 33, a relation among the input voltage Vi, the output voltage Vo, and the duty-designation voltage signal Vd as represented by an expression 34 can be obtained.

$$\frac{{V}_{o}}{{V}_{i}} = {e}^{C \cdot \frac{{V}_{d} - {V}_{top}}{{V}_{top} - {V}_{btm}}} \qquad ( Expression 34 )$$

The expression 34 is substituted into the expression 32 to obtain a relation between the gain compensation ratio Gcmp and the input voltage Vi as represented by an expression 35.

$${G}_{cmp} = C \cdot \frac{{V}_{o}}{{V}_{i}} \qquad ( Expression 35 )$$

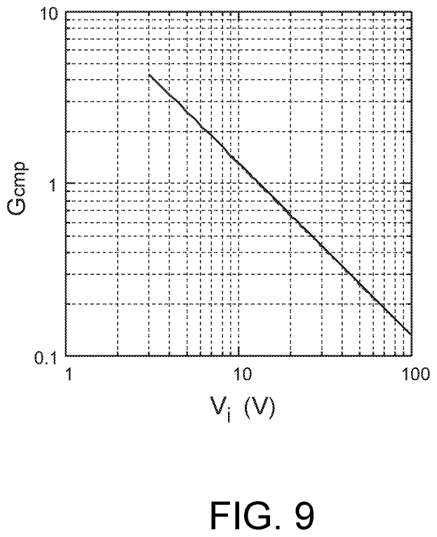

FIG. 9 is a diagram illustrating the relation between the input voltage Vi and the gain compensation ratio Gcmp. The horizontal axis represents the input voltage Vi and the vertical axis represents the gain compensation ratio Gcmp. From the expression 35, the gain compensation ratio Gcmp is inversely proportional to the input voltage Vi. The gain compensation ratio Gcmp has a large value when the input voltage Vi is low and the gain compensation ratio Gcmp becomes the constant C when the input voltage Vi has a substantially same value as the output voltage Vo. As the input voltage Vi increases, the gain compensation ratio Gcmp decreases in inverse proportion thereto.

According to the present embodiment, the gain of the duty-designation voltage signal Vd is compensated by the GCMP 10 using a curve having the input/output characteristics that can be expressed by an exponent function, that is, the voltage transition characteristics being convex downward. Therefore, as the input voltage Vi increases, the time when the potential of the amplitude modulated signal Saw is above the potential of the gain-compensated duty-designation voltage signal VdGcmp of the GCMP 10 decreases, and the time when the input power supply VIN and the switching element of the switching driver 2 are connected with a low resistance reduces, so that an effect of keeping the output voltage Vo at a constant value can be achieved. In this way, influences of the input voltage Vi on the control bandwidth fu (the expression 2) can be canceled without using the input voltage Vi as a criterion. Therefore, according to the present embodiment, a switched-mode power supply in which the voltage acceptable range is wide, the response to load fluctuation is fast, and the output voltage is constant can be provided.

### FOURTH EMBODIMENT

A switched-mode power supply according to a fourth embodiment is different from the switched-mode power supply 100 according to the third embodiment in that the GCMP 10 is inserted between the generator 90 and the PWM 1. Different points from the switched-mode power supply according to the third embodiment are explained below.

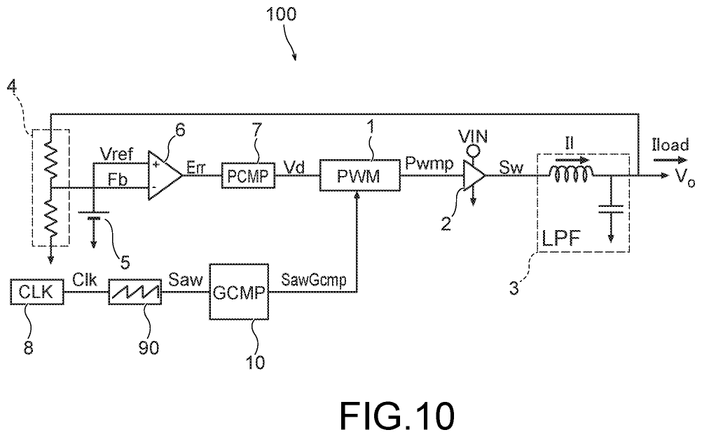

FIG. 10 is a diagram illustrating a configuration example of the switched-mode power supply 100 according to the fourth embodiment. The GCMP 10 according to the fourth embodiment is inserted between the generator 90 and the PWM 1. The GCMP 10 logarithmically converts a voltage VsawGcmp of the signal Saw being an input thereto as represented by an expression 36 and outputs the gain compensated signal SawGcmp. The GCMP 10 according to the present embodiment corresponds to a signal generation circuit, and the generator 90 and the GCMP 10 correspond to a signal output circuit.

$${V}_{sawGcmp} = \frac{{V}_{top} - {V}_{btm}}{C} \cdot log ( \frac{{V}_{saw} - {V}_{btm}}{{V}_{top} - {V}_{btm}} ) + {V}_{top} \qquad ( Expression 36 )$$

The logarithmic function of the expression 36 corresponds to an inverse function of the exponent function of the expression 30 in the third embodiment. Therefore, when the gain compensated signal SawGcmp being an output of the GCMP 10 is applied to the PWM 1, the gain compensation ratio Gcmp (the expression 35) identical to that in the third embodiment can be obtained.

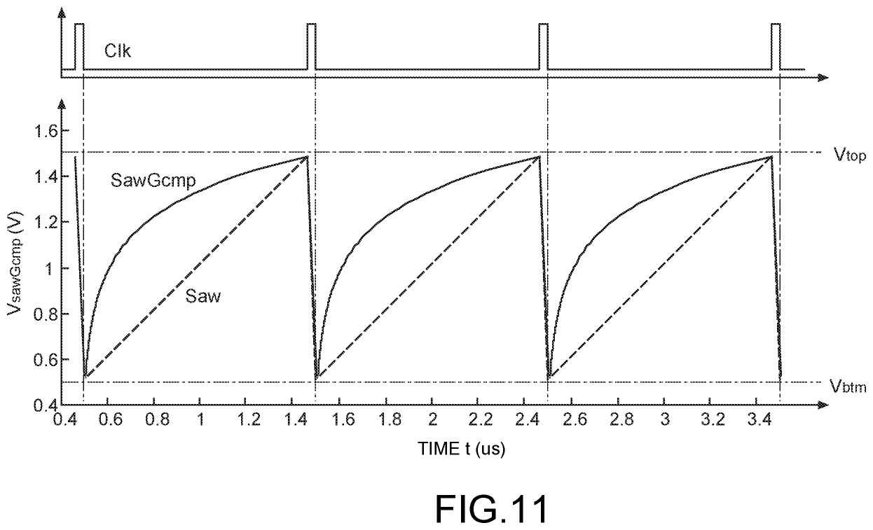

FIG. 11 is a diagram illustrating an operation waveform example of the gain compensated signal SawGcmp. An operation waveform of the clock signal Clk is illustrated in an upper part and an operation waveform example of the signal SawGcmp is illustrated in a lower part. The vertical axis in the upper part represents the ON time of the clock signal Clk, the vertical axis in the lower part represents the voltage VsawGcmp of the gain compensated signal SawGcmp, and the horizontal axis represents a time. When the expression 36 is accurately calculated, the gain compensated signal SawGcmp as an output is infinitesimal when the input signal Saw to the GCMP 10 is equal to the lowest voltage Vbtm. In a practical circuit, the gain compensated signal SawGcmp is an oscillating signal with a constant cycle that vibrates between the lowest voltage Vbtm and the highest voltage Vtop as illustrated in FIG. 11. C in the expression 36 is any constant and is set to a value from about 3 to 5. The reason is same as that in the explanations of the third embodiment. That is, the constant C is set to enable the minimum voltage Vomin of the output voltage Vo to be output when the input power supply VIN is at the allowable maximum voltage Vimax.

In this way, the GCMP 10 converts the input signal Saw into the gain compensated signal SawGcmp according to a voltage transition characteristic curve being convex upward. The curve that has the input/output characteristics being convex upward can be expressed by a logarithmic function.

As described above, the GCMP 10 converts the input signal Saw to the gain compensated signal SawGcmp according to the voltage transition characteristic curve being convex upward. Accordingly, as the input voltage Vi increases, the time when the gain compensated signal SawGcmp is above the duty-designation voltage signal Vd output from the PCMP 7 decreases, and the time when the input power supply VIN and the switching element of the switching driver 2 are connected with a low resistance reduces, so that an effect of keeping the output voltage Vo at a constant value can be achieved. This cancels influences of the input voltage Vi on the control bandwidth fu (the expression 2) without using the input voltage Vi as a criterion. Therefore, according to the present embodiment, a switched-mode power supply in which the voltage acceptable range is wide, the response to load fluctuation is fast, and the output voltage is constant can be provided.

### FIFTH EMBODIMENT

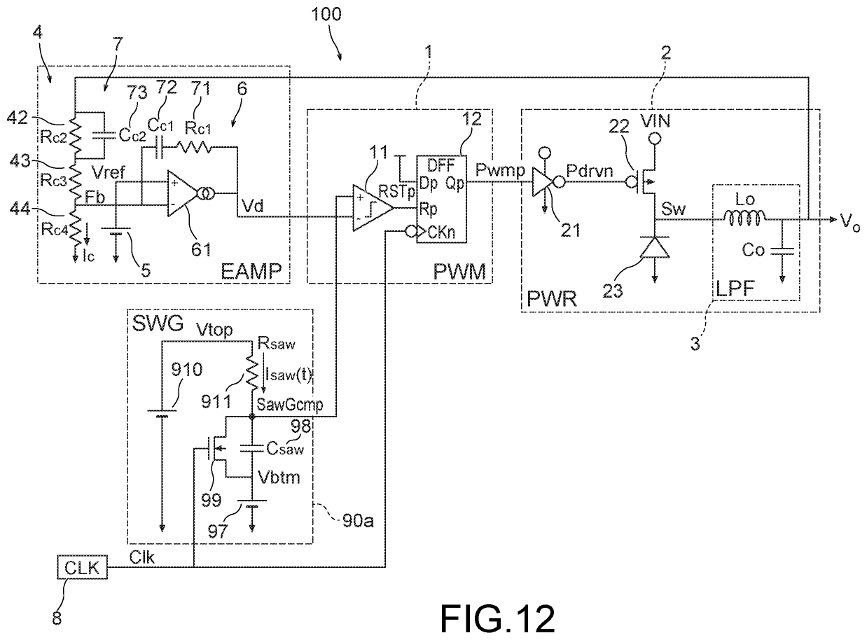

A switched-mode power supply according to a fifth embodiment is a detailed configuration example of the switched-mode power supply according to the fourth embodiment. FIG. 12 is a diagram illustrating a configuration example of the switched-mode power supply 100 according to the fifth embodiment. A specific configuration example of the generator 90 and the GCMP 10 according to the fourth embodiment is illustrated as a gain-compensating generator 90a. Like constituent elements as the bottom voltage source 97, the voltage increase-rate adjusting capacitor 98, and the transistor 99 described in the second embodiment are denoted by like reference numerals and explanations thereof are omitted.

The gain-compensating generator 90a includes the bottom voltage source 97, the voltage increase-rate adjusting capacitor 98, the transistor 99, a top voltage source 910, and a charging resistor 911. One end of the charging resistor 911 is connected to the other terminal of the voltage increase-rate adjusting capacitor 98. The other end of the charging resistor 911 is connected to the top voltage source 910. That is, one end of the top voltage source 910 is connected to the charging resistor 911 and the other end thereof is connected to the grounded power supply.

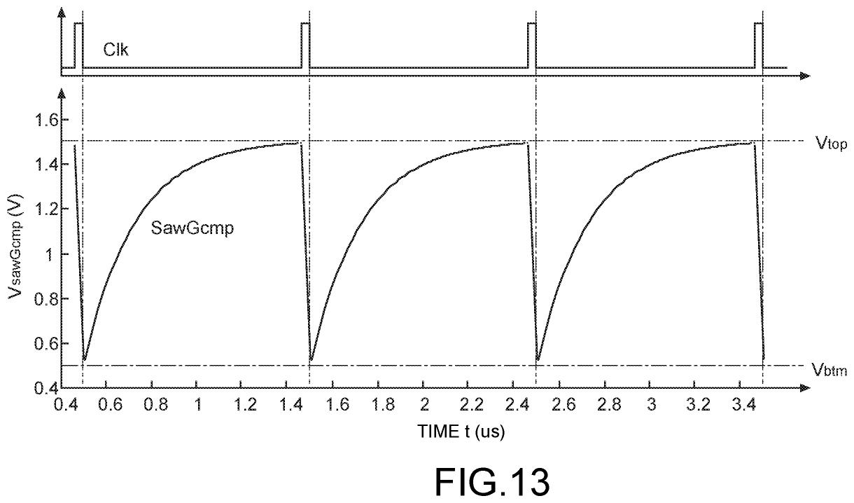

FIG. 13 is a diagram illustrating an operation waveform of the gain-compensating generator 90a. An operation waveform of the clock signal Clk is illustrated in an upper part of FIG. 13 and an operation waveform example of the signal SawGcmp is illustrated in a lower part thereof. The vertical axis in the upper part represents the ON time of the clock signal Clk, the vertical axis in the lower part represents the signal SawGcmp, and the horizontal axis represents a time. The clock signal Clk is a wave signal having a quite small Hi pulse-width duty at a frequency of 1 MHz. When the clock signal Clk is Hi, the transistor 99 is brought into conduction and a resistance between the source terminal and the drain terminal decreases. Accordingly, charges accumulated in the voltage increase-rate adjusting capacitor 98 are emitted and the signal SawGcmp becomes substantially equal to the voltage Vbtm. When the clock signal Clk thereafter becomes Low, the resistance between the source terminal and the drain terminal of the transistor 99 increases. Charges are provided to the voltage increase-rate adjusting capacitor 98 from the top voltage source 910 via the charging resistor 911 and the voltage of the signal SawGcmp gradually increases. This operation is repeated in accordance with the clock signal Clk at the frequency of 1 MHz.

When represented with a time t based on a down edge of the clock signal Clk, the signal SawGcmp can be expressed by an exponent function as an expression 37.

$${V}_{sawGcmp} = {V}_{btm} + ( {V}_{top} - {V}_{btm} ) \cdot ( 1 - {e}^{- \frac{t}{{R}_{s} {C}_{s}}} ) \qquad ( Expression 37 )$$

The exponent function of the expression 37 is different from the logarithmic function of the expression 36 in the fifth embodiment. Therefore, the effect of gain compensation obtained by the present embodiment is different from that in the fifth embodiment and influences of the input voltage Vi on the small-signal transfer gain characteristics cannot be completely suppressed.

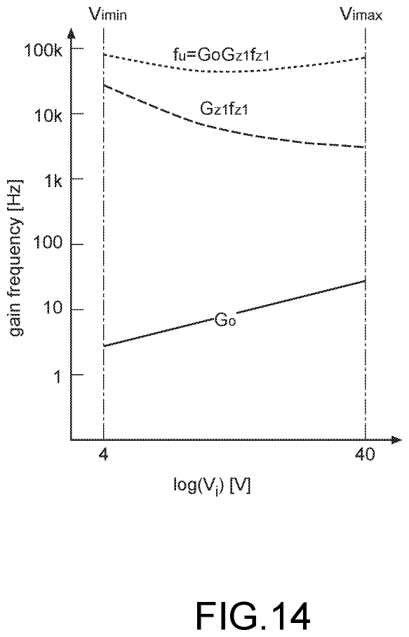

FIG. 14 is a diagram illustrating an example of compensation of the small-signal transfer gain characteristics according to the fifth embodiment. The horizontal axis represents the logarithm of the input voltage Vi and the vertical axis represents the small-signal transfer gain characteristics. The allowable maximum voltage Vimax of the input power supply VIN is represented as 40 and the allowable minimum voltage Vimin is represented as 4. A solid line shows the small-signal transfer gain characteristics Go (the expression 15) from the duty D (the expression 27) to the output voltage Vo, a broken line shows small-signal transfer gain characteristics Gz1fz1 from the output voltage Vo to the duty D (the expression 27), and a dotted line shows the control bandwidth fu (the expression 29). In this case, a relation fu=GoGz1fz1 holds. While the small-signal transfer gain characteristics Go is linear, the small-signal transfer gain characteristics Gz1fz1 is curved. This indicates that, while the small-signal transfer gain characteristics Go of the output stage increases in proportion to the input voltage Vi, the small-signal transfer gain characteristics Gz1fz1 of the control stage is not inversely proportional to the input voltage Vi. Therefore, the control bandwidth fu being the product of the small-signal transfer gain characteristics Go and the small-signal transfer gain characteristics Gz1fz1 is not always constant with respect to the input voltage Vi. However, this indicates that the fluctuation width can be suppressed to about twice.

The slope of the small-signal transfer gain characteristics Go, that is, the relation between the small-signal transfer gain characteristics GoGz1fz1 and the input voltage Vi can be adjusted by a ratio K of a cycle Tclk of the clock signal Clk with respect to the product of the capacitance value Csaw of the voltage increase-rate adjusting capacitor 98 and a resistance value Rsaw of the charging resistor 911 as represented by an expression 38.

$$K = \frac{{T}_{clk}}{{C}_{saw} {R}_{saw}} \qquad ( Expression 38 )$$

As K is larger, the slope of the broken line, that is, compensation of the input voltage Vi with respect to the small-signal transfer gain characteristics Gz1fz1 is larger. It is appropriate that K has a value about 3 to 5.

As described above, according to the present embodiment, the pulse width modulation is applied using the signal SawGcmp having the voltage transition characteristics being convex upward. This can reduce influences of the input voltage Vi on the feedback bandwidth fu. Further, the generator 9 that generates the signal SawGcmp can be constituted by a simple RC delay circuit. Therefore, according to the present embodiment, a switched-mode power supply in which the voltage acceptable range is wide, the response to load fluctuation is fast, and the output voltage Vo is constant can be provided inexpensively.

### SIXTH EMBODIMENT

The PWM 1 according to a sixth embodiment is different from those in the first embodiment and the second embodiment in receiving the duty-designation voltage signal Vd and the gain compensated signal SawGcmp as inputs and outputting a step-down pulse-width modulated signal Pwmbkp, a step-up pulse-width modulated signal Pwmbtp, and a step-up/down operation signal Bbdurp. Different points from the first embodiment and the second embodiment are explained below.

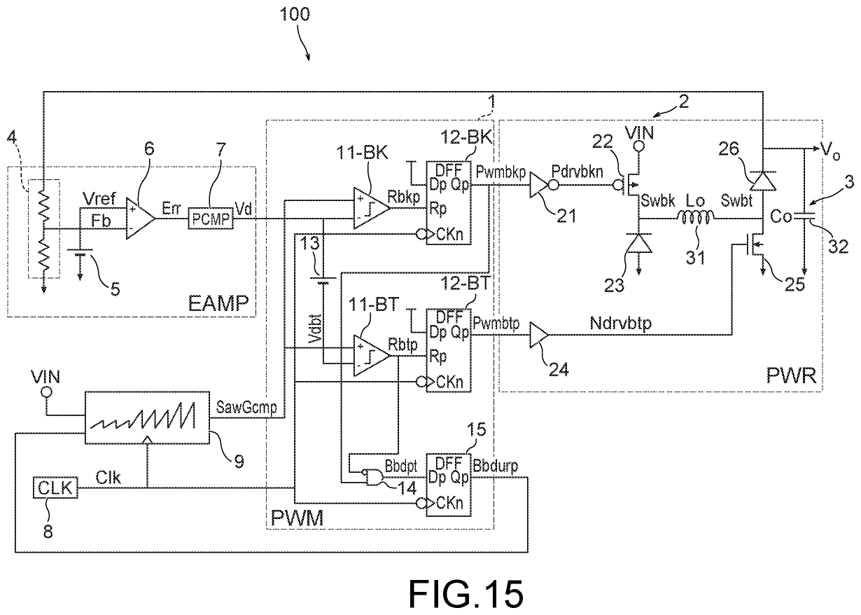

FIG. 15 is a diagram illustrating a configuration example of the switched-mode power supply 100 according to the sixth embodiment.

The switched-mode power supply 100 according to the sixth embodiment includes the PWM 1, the switching driver 2, the LC low-pass filter 3, the voltage divider 4, the reference voltage source 5, the error amplifier 6, the PCMP 7, the clock oscillator 8, and the gain-compensating generator 9. The step-down pulse-width modulated signal Pwmbkp and the step-up pulse-width modulated signal Pwmbtp are both input to the switching driver 2 and the step-up/down operation signal Bbdurp is input to the gain-compensating generator 9. The PWM 1 includes a step-down voltage comparator 11-BK, a step-down D flip-flop 12-BK, a step-up voltage comparator 11-BT, a step-up D flip-flop 12-BT, a duty-designation voltage subtractor 13, a step-up/down operation determination logic circuit 14, and a step-up/down operation detection-signal latch D flip-flop 15. The duty-designation voltage subtractor 13 is constituted by an ideal voltage source. The generator 9 according to the present embodiment corresponds to a signal output circuit and a signal generation circuit.

The gain-compensating generator 9 is connected to a non-inverting input terminal of the step-down voltage comparator 11-BK and the PCMP 7 is connected to an inverting input terminal thereof. An output terminal of the step-down voltage comparator 11-BK is connected to a reset terminal Rp of the step-down D flip-flop 12-BK. The step-down voltage comparator 11-BK sets a step-down pulse reset signal Rbkp to Hi when detecting that the potential Vsaw of the gain compensated signal SawGcmp input from the gain-compensating generator 9 has exceeded the potential Vd of a pulse-width-designation voltage signal Vd input from the PCMP 7, and sets the step-down pulse reset signal Rbkp to Low in other cases.

The clock oscillator 8 is connected to an inverting clock input terminal CKn of the step-down D flip-flop 12-BK, the output terminal of the step-down voltage comparator 11-BK is connected to the reset terminal Rp thereof, and a step-down pre-driver 21 is connected to an output terminal thereof. A signal being always Hi is input to a data input terminal Dp of the step-down D flip-flop 12-BK.

Accordingly, at an instant when the clock signal Clk output from the clock oscillator 8 changes to Low, the step-down D flip-flop 12-BK receives the always-Hi signal input to the data input terminal Dp as an input, retains the signal therein, and simultaneously outputs the step-down pulse-width modulated signal Pwmbkp as Hi from the data output terminal Qp. When the step-down pulse reset signal Rbkp is Hi, the step-down D flip-flop 12-BK resets an internal signal to Low regardless of the inverting clock terminal CKn and the data input terminal Dp, and sets the pulse-width modulated signal Pwmbkp output from the data output terminal Qp to Low.

Configurations and operations of the step-up voltage comparator 11-BT and the step-up D flip-flop 12-BT are identical to those of the step-down voltage comparator 11-BK and the step-down D flip-flop 12-BK. However, they are different in that a negative voltage terminal of the duty-designation voltage subtractor 13 is connected to an inverting input terminal of the step-up voltage comparator 11-BT and a step-up pre-driver 24 is connected to an output terminal of the step-up D flip-flop 12-BT.

The step-down pulse-width-designation voltage signal Vd is connected to a positive voltage terminal of the duty-designation voltage subtractor 13 and a step-up pulse-width-designation voltage signal Vdbt is connected to the negative voltage terminal thereof. The duty-designation voltage subtractor 13 outputs the step-up pulse-width-designation voltage signal Vdbt of a potential obtained by subtracting a step-up/down duty-difference gap voltage V_{gap} from the potential Vd of the step-down pulse-width-designation voltage signal Vd. While an ideal voltage source is used, the duty-designation voltage subtractor 13 can be a circuit of any configuration as long as it performs an action of subtracting the step-up/down duty-difference gap voltage V_{gap}.

The step-up/down duty-difference gap voltage V_{gap} is a parameter for adjusting the ratio between the input voltage Vi and the output voltage Vo at which three operations of a step-up operation, a step-up/down operation, and a step-down operation are switched. The parameter is preferably set to a value slightly smaller than an amplitude Vtop−Vbtm of the gain compensated signal SawGcmp as represented by an expression 39. That is, the value of a coefficient K is preferably set to a value slightly smaller than 1.

V_{gap}=K(Vₜₒₚ−V_{btm})

where K=0.5 to 1 (Expression 39)

One of input terminals of the step-up/down operation determination logic circuit 14 is connected to the output terminal of the step-down D flip-flop 12-BK, the other input terminal is connected to an output terminal of the step-up voltage comparator 11-BT, and an output terminal thereof is connected to a data input terminal Dp of the step-up/down operation detection-signal latch D flip-flop 15. Accordingly, the step-down pulse-width modulated signal Pwmbkp is input to one of the input terminals of the step-up/down operation determination logic circuit 14, a step-up pulse reset signal RBTp is input to the other input terminal thereof, and a step-up/down operation detection signal Bbdtp is output from the output terminal thereof.

The step-up/down operation determination logic circuit 14 determines that a step-up/down operation is being performed and sets the step-up/down operation detection signal Bbdtp to Hi when the step-down pulse-width modulated signal Pwmbkp is Hi and the step-up pulse reset signal Rbtp is Low.

The output terminal of the step-up/down operation determination logic circuit 14 is connected to the data input terminal Dp of the step-up/down operation detection-signal latch D flip-flop 15, the clock oscillator 8 is connected to an inverting clock terminal CKn thereof, and a data output terminal Qp thereof is connected to the gain-compensating generator 9. Accordingly, the step-up/down operation detection signal Bbdtp is input to the data input terminal Dp of the step-up/down operation detection-signal latch D flip-flop 15, and the clock signal Clk is input to the inverting clock terminal CKn. The step-up/down operating signal Bbdurp is output from the data output terminal Qp to the gain-compensating generator 9.

The step-up/down operation detection-signal D flip-flop 15 holds the step-up/down operation detection signal Bbdtp therein at an instant when the clock signal Clk becomes Low, and then outputs the step-up/down operating signal Bbdurp. The step-up/down operation detection-signal D flip-flop 15 retains the step-up/down operation detection signal Bbdtp therein until a next instant when the clock signal Clk becomes Low.

The switching driver 2 and the LC low-pass filter 3 constitute a power stage PWR. This switching driver 2 includes a step-down pre-driver 21, a step-down transistor 22, a step-down asynchronous power diode 23, the step-up pre-driver 24, a step-up switching-driver N-type MOS transistor 25, and a step-up asynchronous power diode 26. The LC low-pass filter 3 includes an output inductor 31 and an output capacitor 32.

The step-down pre-driver 21 has an input terminal connected to the output terminal Qp of the step-down D flip-flop 12-BK, and an output terminal connected to a gate terminal of the step-down transistor 22. The step-down pulse-width modulated signal Pwmbkp is input to the input terminal of the step-down pre-driver 21 and a step-down drive signal Pdrvbkn is output from the output terminal.

The drive signal Pdrvbkn for the step-down transistor 22 is an inverted signal that is Low when the step-down pulse-width modulated signal Pwmbkp is Hi and is Hi in other cases. However, the potential is subjected to level conversion to become the input voltage Vi when the signal is Hi and to become a potential at which the step-down transistor 22 is brought into conduction with a sufficiently low resistance value, for example, a potential about 5 volts lower than the input voltage Vi when the signal is Low.

The gate terminal of the step-down transistor 22 is connected to the output terminal of the step-down pre-driver 21, a source terminal thereof is connected to the input power supply VIN, and a drain terminal thereof is connected to a cathode terminal of the step-down asynchronous power diode 23 and one end of the output inductor 31. Accordingly, the step-down drive signal Pdrvbkn is input to the gate terminal of the step-down transistor 22, the input voltage Vi is input to the source terminal, and a step-down switching signal Swbk is output from the drain terminal.

The cathode terminal of the step-down asynchronous power diode 23 is connected to the drain terminal of the step-down transistor 22, and an anode terminal thereof is connected to the grounded power supply. The potential of the step-down switching signal Swbk transitions between the input voltage Vi and 0 volt being the potential of the grounded power supply in accordance with the step-down pulse-width modulated signal Pwmbkp.

An input terminal of the step-up pre-driver 24 is connected to an output terminal of the step-up D flip-flop 12-BT, and an output terminal thereof is connected to a gate terminal of the step-up switching-driver N-type MOS transistor 25. Accordingly, the step-up pulse-width modulated signal Pwmbtp is input to the input terminal of the step-up pre-driver 24 and a step-up switching-driver N-type MOS transistor gate-drive signal Ndrvbtp is output from the output terminal thereof.

The transistor gate-drive signal Ndrvbtp is a non-inverted signal that is Hi when the step-up pulse-width modulated signal Pwmbtp is Hi and is Low in other cases. The potential thereof is subjected to level conversion to become 0 volt being the potential of the grounded power supply when the signal is Low and become a potential at which the step-up switching-driver N-type MOS transistor 25 is brought into conduction with a sufficiently low resistance value, for example, a potential of about 5 volts when the signal is Hi.

The step-up switching-driver N-type MOS transistor 25 has the gate terminal connected to the output terminal of the step-up pre-driver 24, a source terminal connected to the grounded power supply, and a drain terminal connected to an anode terminal of the step-up asynchronous power diode 26. That is, the drain terminal of the step-up pre-driver 24 is connected to the anode terminal of the step-up asynchronous power diode 26 and one of terminals of the output capacitor 32 is connected to a cathode terminal thereof. The potential of a step-up switching signal Swbt transitions between the output voltage Vo and 0 volt being the potential of the grounded power supply in accordance with the step-up pulse-width modulated signal Pwmbtp.

The cathode terminal of the step-down transistor 22 and one end of the output inductor 31 are connected to one of terminals of the output inductor 31 and the input terminal of the step-up asynchronous power diode 26 and the drain terminal of the step-up switching-driver N-type MOS transistor 25 are connected to the other terminal.

An output terminal that outputs the output voltage Vo is connected to one of terminals of the output capacitor 32, and the grounded power supply is connected to the other terminal.

In this way, the output inductor 31 and the output capacitor 32 are connected via the step-up asynchronous power diode 26 to constitute a LC low-pass filter. Accordingly, the inductor current IL flowing through the output inductor 31 is controlled.

The feedback control loop controls the output voltage Vo to be kept at a value represented by an expression 40 using the reference voltage Vref and the voltage division ratio Ho of the voltage divider 4.

$$V o = \frac{V ref}{{H}_{o}} \qquad ( Expression 40 )$$

Detailed configurations and operations are identical to those of the first embodiment and the second embodiment.

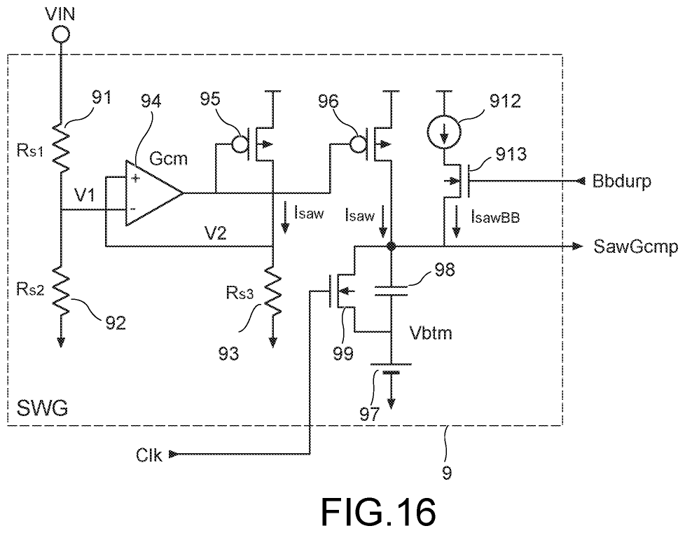

FIG. 16 is a diagram illustrating a detailed configuration example of the gain-compensating generator 9 used in the present embodiment. The configuration is substantially same as that of the gain-compensating generator 9 according to the second embodiment and a step-up/down operation gain-compensating constant current source 912 and a step-up/down operation gain-compensating N-type MOS transistor 913 are added thereto. Other like constituent elements are denoted by like reference numerals and explanations thereof are omitted.

One of terminals of the step-up/down operation gain-compensating constant current source 912 is connected to an internal power supply and causes a constant step-up/down operation gain-compensating current Isaw_{BB} to flow into the gain compensated signal SawGcmp via the step-up/down operation gain-compensating N-type MOS transistor 913. The other terminal of the step-up/down operation gain-compensating constant current source 912 is connected to a source terminal of the step-up/down operation gain-compensating N-type MOS transistor 913, the gain compensated signal SawGcmp is connected to a drain terminal thereof, and one end of the voltage increase-rate adjusting capacitor 98 and a source terminal of the reset N-type MOS transistor 99 are connected to a gate terminal thereof. The step-up/down operation gain-compensating N-type MOS transistor 913 is brought into conduction to charge the voltage increase-rate adjusting capacitor 98 having the capacitance value Csaw with the step-up/down operation gain-compensating current Isaw_{BB} when the step-up/down operating signal Bbdurp is Hi, and interrupts the step-up/down operation gain-compensating current Isaw_{BB} in other cases.

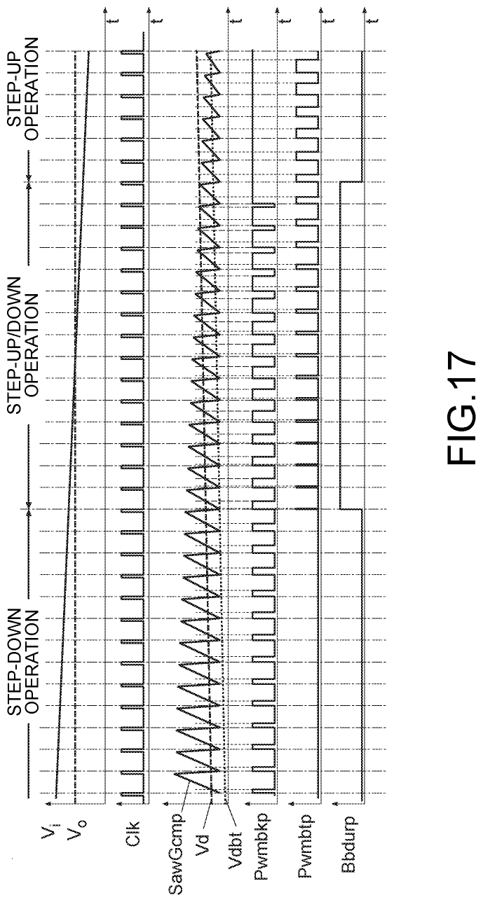

FIG. 17 is a waveform chart for explaining an operation according to the sixth embodiment. A solid line in a top part shows the input voltage Vi and a broken line shows the output voltage Vo. An up switched-mode power supply according to the present embodiment performs a step-down operation when the input voltage Vi is higher than the output voltage Vo and performs a step-up operation when the input voltage Vi is conversely lower than the output voltage Vo. When both voltages are substantially equal, a step-up/down operation is performed. The operations are automatically switched by an action of the feedback control loop.

A solid line in a part below shows the clock signal Clk. The clock signal Clk is a wave signal with a constant cycle where the Hi pulse-width duty is extremely low. A solid line in a part below shows the gain compensated signal SawGcmp, a broken line shows the duty-designation voltage signal Vd, and a dotted line shows the step-up duty-designation voltage signal Vdbt. The gain compensated signal SawGcmp is a signal that has an amplitude changing according to the input voltage Vi.

The feedback control loop works to keep the output voltage Vo constant by changing the duty-designation voltage signal Vd and the step-up duty-designation voltage signal Vdbt with respect to the voltage of the gain compensated signal SawGcmp. A solid line in a part below shows the step-down pulse-width modulated signal Pwmbkp. The step-down pulse-width modulated signal Pwmbkp transitions to Hi at an instant when the clock signal Clk becomes Low and thereafter transitions to Low at an instant when the potential of the gain compensated signal SawGcmp becomes higher than the potential of the duty-designation voltage signal Vd. The Hi-pulse width duty is controlled by an action of the feedback control loop and is small when the input voltage Vi is sufficiently higher than the output voltage Vo, increases as the input voltage Vi decreases, and finally becomes always Hi when the potential relation is reversed.

A solid line in a part below shows the step-up pulse-width modulated signal Pwmbtp. The step-up pulse-width modulated signal Pwmbtp transitions to Hi at an instant when the clock signal Clk becomes Low and thereafter transitions to Low at an instant when the potential of the gain compensated signal SawGcmp becomes higher than the potential of the step-up duty-designation voltage signal Vdbt. The Hi-pulse width duty of the step-up pulse-width modulated signal Pwmbtp is controlled by an action of the feedback control loop. The step-up pulse-width modulated signal Pwmbtp is always Low when the input voltage Vi is higher than the output voltage Vo. When the input voltage Vi decreases to approach the output voltage Vo, pulses of a quite small duty start appearing and the duty enlarges as the input voltage Vi becomes lower than the output voltage Vo. In the bottom part, the step-up/down operating signal Bbdurp is illustrated. When both the step-down pulse-width modulated signal Pwmbkp and the step-up pulse-width modulated signal Pwmbtp appear in one cycle of the clock signal Clk, it is determined that a step-up/down operation is being performed and the step-up/down operating signal Bbdurp becomes Hi.

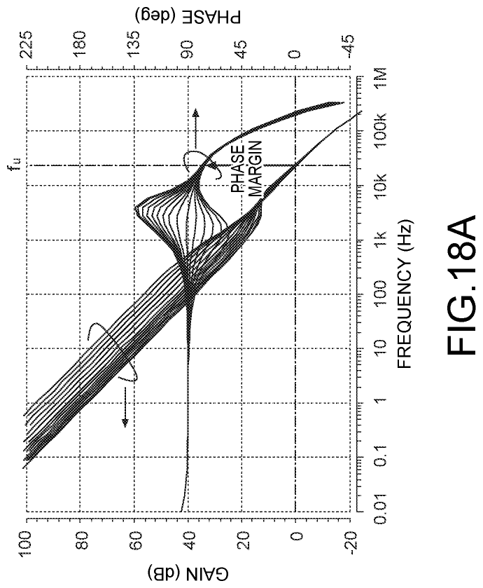

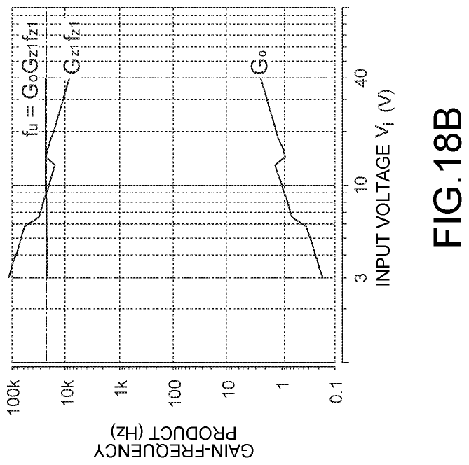

FIG. 18A is a Bode plot of the feedback control loop according to the present embodiment. The horizontal axis represents the logarithm of the small-signal frequency, the vertical axis represents the small-signal transfer gain characteristics in dB, and the right-side axis represents the small-signal transfer phase characteristics. This is a diagram illustrating gain characteristics and phase characteristics in plural conditions where the input voltage Vi is changed from 3 volts to 40 volts, plotted to be superimposed on this graph.

In a frequency region lower than the loop control bandwidth fu, these characteristics are influenced by the input voltage Vi and are each divided into a plurality of curves. However, in a higher frequency region, the curves of these characteristics each converge to almost one curve. Therefore, the loop control bandwidth fu is constant regardless of the input voltage Vi and the phase margin is also constant at about 80°.

FIG. 18B is a diagram illustrating dependency on the input voltage Vi of the small-signal gain-frequency product obtained from the Bode plot. The horizontal axis represents the input voltage and the vertical axis represents the gain-frequency product. A solid line shows the gain-frequency product Go of the power stage, a broken line shows the gain-frequency product Gz1fz1 of the control stage, and a dotted line shows the gain-frequency product GoGz1fz1 of the open-loop transfer characteristics of the feedback control, that is, the feedback control bandwidth fu. The gain-frequency product Go of the power stage depends on the input voltage Vi and increases in proportion thereto. The gain-frequency product Go of the power stage has a discontinuous portion and is convex upward. This is because a step-up-side driver and a step-down-side driver simultaneously operate at the time of a step-up/down operation and thus the small-signal transfer gain increases by about 1.6 times. The gain-frequency product Gz1fz1 is compensated to cancel the dependency on the input voltage Vi.

The gain-compensating generator 9 charges the voltage increase-rate adjusting capacitor 98 with the current Isaw proportional to the input voltage Vi. Besides, when the step-up/down operating signal Bbdurp is Hi, the constant current Isaw_{BB} is added to charge the voltage increase-rate adjusting capacitor 98. When this gain compensated signal SawGcmp is used for the PWM 1, the gain-frequency product Gz1fz1 of the control stage that is inversely proportional to the input voltage Vi and that further restricts the gain during the step-up/down operation can be obtained.

The dependencies on the input voltage Vi of the gain-frequency product Go of the power stage and of the gain-frequency product Gz1fz1 of the control stage cancel each other out and the feedback control bandwidth fu is kept constant regardless of the input voltage Vi.

As explained above, according to the present embodiment, the operation to keep the output voltage Vo constant is performed by changing the duty-designation voltage signal Vd and the step-up duty-designation voltage signal Vdbt with respect to the voltage of the gain compensated signal SawGcmp. Accordingly, an up switched-mode power supply having a wide voltage allowable range and fast load response characteristics can be provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A switched-mode power supply comprising:
a switching circuit configured to switch an input voltage according to a pulse drive signal synchronous with a clock signal to output a voltage of a pulse waveform;
a smoothing circuit configured to convert the voltage of the pulse waveform into a DC voltage to output an output voltage;
a differential-signal output circuit configured to output a differential signal based on a potential difference between the output voltage and a reference potential;
a signal output circuit configured to output a signal synchronous with the clock signal;
a pulse-drive signal output circuit configured to adjust a time ratio of outputting the voltage on a basis of a time point when the differential signal and the signal have a same value, and to output the pulse drive signal; and
a signal generation circuit configured to generate at least either the differential signal or the signal to cause an interval from a base time in one cycle of the clock signal to the time point to decrease as the input voltage increases.

2. The switched-mode power supply of claim 1, wherein the signal generation circuit generates a value of the differential signal on a basis of a curve having input/output characteristics being convex downward.

3. The switched-mode power supply of claim 2, wherein the curve can be represented by an exponent function.

4. The switched-mode power supply of claim 1, wherein the signal generation circuit generates a value of the signal on a basis of a curve having input/output characteristics being convex upward.

5. The switched-mode power supply of claim 4, wherein the curve can be represented by a logarithmic function.

6. The switched-mode power supply of claim 1, wherein the signal generation circuit changes an amplitude of the signal according to the input voltage.

7. The switched-mode power supply of claim 6, wherein the signal generation circuit causes the amplitude of the signal to be proportional to the input voltage.

8. The switched-mode power supply of claim 6, further comprising a second smoothing circuit configured to suppress high-frequency waves of the output voltage, wherein
the signal generation circuit causes the amplitude of the signal to be proportional to the input voltage having high-frequency waves suppressed by the second smoothing circuit.

9. The switched-mode power supply of claim 6, wherein the pulse-drive signal output circuit outputs a pulse drive signal having a time ratio adjusted on a basis of a comparison value between at least either the differential signal or a second differential signal obtained by lowering the differential signal by a predetermined value, and the signal.

10. A switched-mode power supply comprising:
a switching circuit configured to switch an input voltage according to a pulse drive signal synchronous with a clock signal to output a voltage of a pulse waveform;
a smoothing circuit configured to convert the voltage of the pulse waveform into a DC voltage to output an output voltage;
a differential-signal output circuit configured to output a differential signal based on a potential difference between the output voltage and a reference potential;
a signal output circuit configured to output a signal synchronous with the clock signal; and
a pulse-drive signal output circuit configured to adjust a time ratio of outputting the voltage on a basis of a time point when the differential signal and the signal have a same value, and to output the pulse drive signal synchronous with the clock signal.

11. The switched-mode power supply of claim 10, wherein the differential-signal output circuit outputs a differential signal according to a potential difference between the output voltage and a reference potential on a basis of a curve having input/output characteristics being convex downward.

12. The switched-mode power supply of claim 10, wherein the signal output circuit outputs a value of a signal synchronous with the clock signal on a basis of a curve having input/output characteristics being convex upward.

13. A self-driving device comprising
a controlling computer or a maneuvering motor, wherein
the controlling computer or the maneuvering motor comprises:
a switching circuit configured to switch an input voltage according to a pulse drive signal synchronous with a clock signal to output a voltage of a pulse waveform;
a smoothing circuit configured to convert the voltage of the pulse waveform into a DC voltage to output an output voltage;
a differential-signal output circuit configured to output a differential signal based on a potential difference between the output voltage and a reference potential;
a signal output circuit configured to output a signal synchronous with the clock signal;
a pulse-drive signal output circuit configured to adjust a time ratio of outputting the voltage on a basis of a time point when the differential signal and the signal have a same value, and to output the pulse drive signal; and
a signal generation circuit configured to generate at least either the differential signal or the signal to cause an interval from a base time in one cycle of the clock signal to the time point to decrease as the input voltage increases.

14. The self-driving device of claim 13, wherein the signal generation circuit generates a value of the differential signal on a basis of a curve having input/output characteristics being convex downward.

15. The self-driving device of claim 14, wherein the curve can be represented by an exponent function.

16. The self-driving device of claim 13, wherein the signal generation circuit generates a value of the signal on a basis of a curve having input/output characteristics being convex upward.

17. The self-driving device of claim 16, wherein the curve can be represented by a logarithmic function.

18. The self-driving device of claim 13, wherein the signal generation circuit changes an amplitude of the signal according to the input voltage.

19. The self-driving device of claim 18, wherein the signal generation circuit causes the amplitude of the signal to be proportional to the input voltage.

20. The self-driving device of claim 18, further comprising a second smoothing circuit configured to suppress high-frequency waves of the output voltage, wherein
the signal generation circuit causes the amplitude of the signal to be proportional to the input voltage having high-frequency waves suppressed by the second smoothing circuit.
